(19) United States
(12) Patent Application Publication
(10) Pub. No.: US 2018/0025289 A1
(43) Pub. Date: Jan. 25, 2018

(54) Performance Provisioning Using Machine Learning Based Automated Workload Classification

(71) Applicant: QUALCOMM Incorporated, San Diego, CA (US)

(72) Inventors: Paras Surendra Doshi, Bangalore (IN); Manish Goel, Bangalore (IN); Ayush Agarwal, Bangalore (IN); Kunal Punjabi, Vadodara (IN)

(21) Appl. No.: 15/634,215

(22) Filed: Jun. 27, 2017

Related U.S. Application Data
(63) Continuation-in-part of application No. 15/257,491, filed on Sep. 6, 2016.
(60) Provisional application No. 62/364,451, filed on Jul. 20, 2016.

(51) Int. Cl. G06N 99/00; G06F 9/50

(52) U.S. Cl. CPC G06N 99/005; G06F 9/50

(57) ABSTRACT

Various aspects may include methods, computing devices implementing such methods, and non-transitory processor-readable media storing processor-executable instructions implementing such methods for improving battery life with performance provisioning using machine learning based automated workload classification. Various aspects may include creating a machine learning model based at least in part on computing device metrics, training the machine learning model using performance provisioning rules for work groups; classifying a new work item for a software application into a work group using the trained machine learning model, and applying resource provisioning rules for the work group to the new work item.

### CROSS-REFERENCE TO RELATED APPLICATIONS

This application is a continuation-in-part of U.S. Non-Provisional application Ser. No. 15/257,491 entitled “Performance Provisioning Using Machine Learning Based Automated Workload Classification” filed Sep. 6, 2016. This application also claims the benefit of priority under C.F.R. 371(c) of U.S. Provisional Application No. 62/364,451 entitled “Performance Provisioning Using Machine Learning Based Automated Workload Classification” filed Jul. 20, 2016. The entire contents of both of these applications are hereby incorporated by reference.

### BACKGROUND

The increasing complexity of software applications leads to greater demand on computing device power resources. The performance needs of a software application are considered to be acceptable when the provisioning is within a range of its real requirement.

Most computing devices having a system-on-chip architecture are incapable of determining performance provisioning for software applications because only the central processing unit (CPU) utilization is examined during performance need evaluation. This practice of CPU utilization-based provisioning often over-estimates the actual provisioning needs of executing software applications, and thus over provisions the application in a manner that results in an unnecessary drain on battery life. This is because current SoC provisioning schemes do not account for the type of work being carried about by a software application process. Standard performance provisioning attempts to optimize for performance, which can waste power. Such provisioning may over-provision CPUs that experience high utilization while the rest of the CPUs may or may not be overprovisioned.

### SUMMARY

Various aspects may include methods, computing devices with processors implementing methods, and non-transitory processor-readable storage media including instructions configured to cause a processor to execute operations of the methods for performance provisioning of applications executing on a computing device. Various aspects may include a processor of a computing device generating a work group, classifying a new work item for a software application into the generated work group using a work classification model, selecting a set of provisioning rules for the work item based, at least in part, on the work group to which the work item was classified, and executing the work item according to the selected set of provisioning rules.

In some aspects, generating the work group may include the computing device identifying that a first set of collected computing device metric data belongs to a work group, collecting a second set of computing device metric data, analyzing the first set of collected computing device metric data and the second set of collected computing device metric data to obtain a measured quantity, determining whether the first set of collected computing device metric data and the second set of collected computing device metric data belong to the same work group based on the measured quantity, determining whether the first set of collected computing device metric data and the second set of collected computing device metric data represent the software application work groups in response to determining that the first set of collected computing device metric data and the second set of collected computing device metric data belong to the same work group, and ending a current data collection session in response to determining that the first set of collected computing device metric data and the second set of collected computing device metric data represent the software application work groups. In such aspects, the computing device metrics may include at least one of graphical processing unit (GPU) frequency range, central processing unit (CPU) frequency for a cluster of little CPUs, CPU frequency for a cluster of big CPUs, CPU utilization of the cluster of little CPUs, CPU utilization of the cluster of big CPUs, or advanced RISC machine (ARM) instructions.

Such aspects may include the computing device determining whether a minimum amount of computing device metric data has been collected in response to determining that the first set of collected computing device metric data and the second set of collected computing device metric data belong to the same work group, wherein determining whether the first set of collected computing device metric data and the second set of collected computing device metric data represent the software application work groups is performed further in response to determining that a minimum amount of computing device metric data has been collected.

In such aspects, the measured quantity may include one or more of a mean, standard deviation, median, number of outliers, percentage of outliers, or a coefficient of variation.

Some aspects may include the computing device storing performance metrics of classified work items, determining whether the stored performance metrics meet a performance quality threshold, and training the work classification model in response to determining that the stored performance metrics do not meet the performance quality threshold.

Some aspects may include the computing device storing performance metrics of classified work items, transmitting the stored performance metrics to a remote server, and receiving an updated work classification model from the remote server. Such aspects may include the computing device determining whether the stored performance metrics meet a performance quality threshold, and transmitting a request for an updated classification model in response to determining that the stored performance metrics do not meet a performance quality threshold.

In some aspects, classifying a new work item for a software application into a work group using the work classification model may include the computing device matching a software application type of the software application to which the work item belongs to a software application type associated with one or more work groups.

Further aspects include a computing device having one or more processors configured with processor-executable instructions to perform operations of the methods summarized above. Further aspects include a computing device having means for performing functions of the methods summarized above. Further aspects include a non-transitory processor-readable storage medium on which is stored processor-executable instructions configured to cause a processor of a computing device to perform operations of the methods summarized above.

### BRIEF DESCRIPTION OF THE DRAWINGS

The accompanying drawings, which are incorporated herein and constitute part of this specification, illustrate example aspects of the methods and devices. Together with the general description given above and the detailed description given below, the drawings serve to explain features of the methods and devices, and not to limit the disclosed aspects.

FIG. 1 is a block diagram illustrating a computing device suitable for use with various aspects.

FIG. 2 is a communications system block diagram of a network suitable for use with the various aspects.

FIG. 3 is a process flow diagram illustrating methods for performance provisioning according to various aspects.

FIG. 4 is a process flow diagram illustrating a method for generating work groups for characterizing the performance provisioning needs of software application work items according to various aspects.

FIGS. 5A-5B are process flow diagrams illustrating methods for updating a work classification model according to various aspects.

FIG. 6 is a block diagram illustrating a server computing device suitable for use with various aspects.

FIG. 7 is a process flow diagram illustrating a method for generating a work classification model according to various aspects.

FIG. 8 is a process flow diagram illustrating a method for training a work classification model according to various aspects.

FIG. 9 is a block diagram illustrating logical blocks of a computing device implementing the various aspects.

FIG. 10 is a process flow diagram illustrating a method for operation within a logical block of a communications device according to various aspects.

FIG. 11 is a process flow diagram illustrating a method for operation within a logical block of a communications device according to various aspects.

FIGS. 12A-12C are process flow diagrams illustrating a method for operations within a logical block of a communications device according to various aspects.

FIG. 13 is a process flow diagram illustrating a method for error correction during work classification according to various aspects.

FIG. 14 is a process flow diagram illustrating a method for updating a work classification model according to various aspects.

### DETAILED DESCRIPTION

Various aspects will be described in detail with reference to the accompanying drawings. Wherever possible the same reference numbers will be used throughout the drawings to refer to the same or like parts. References made to particular examples and aspects are for illustrative purposes, and are not intended to limit the scope of the claims.

Various aspects include provisioning methods that automatically distinguish between types of work required by software application, and apply performance provisioning suited to types of work being performed, considering real provisioning performance needed by various tasks, in order to improve battery life and thermal response of the computing device. Since key performance indicators are not always readily available, adding more system metrics to performance provisioning decision-making may improve the search for the real performance provisioning needs. Some aspects may include generating new work groups and software application types during deployment of work classification models.

The terms “computing device” is used herein to refer to any one or all of a variety of computers and computing devices, digital cameras, digital video recording devices, non-limiting examples of which include smart devices, wearable smart devices, desktop computers, workstations, servers, cellular telephones, smart phones, wearable computing devices, personal or mobile multi-media players, personal data assistants (PDAs), laptop computers, tablet computers, smart books, palm-top computers, wireless electronic mail receivers, multimedia Internet enabled cellular telephones, wireless gaming controllers, mobile robots, and similar personal electronic devices that include a programmable processor and memory.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) is used herein to refer to a single module or package that contains multiple resources, computational units, cores and/or processors on two or more IC chips or substrates. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single mobile computing device. The proximity of the SOCs facilitates high-speed communications and the sharing of memory and resources. An SOC may include multiple multicore processors, and each processor in an SOC may be referred to as a core.

The term “multiprocessor” is used herein to refer to a system or device that includes two or more processing units configured to read and execute program instructions.

In overview, the various aspects may include methods, computing devices implementing such methods, and non-transitory processor-readable media storing processor-executable instructions implementing such methods for improving battery life with performance provisioning using machine learning based automated workload classification. Various aspects may include creating a machine learning model based at least in part on computing device metrics, training the machine learning model using performance provisioning rules for work groups, classifying a new work item for a software application into a work group using the trained machine learning model, and applying resource provisioning rules for the work group to the new work item.

The various aspects may monitor or observe various system metrics as software application work items execute in order to properly classify work items into one or more work groups. The computing device may monitor computing device metrics including one or more of graphical processing unit (GPU) frequency range, central processing unit (CPU) frequency for a cluster of little CPUs, CPU frequency for a cluster of big CPUs, CPU utilization of the cluster of little CPUs, CPU utilization of the cluster of big CPUs, and/or advanced RISC machine (ARM) instructions. These features are for illustration purposes and are not intended to be limiting. Additional features may be monitored according to various aspects. In most SoCs, there are many more processing blocks apart from the CPU and GPU. For example, SoCs have video processing blocks, one or more modems, a Wi-Fi block, a Bluetooth block, etc. To make the performance provisioning model more accurate, various aspects may expose and add features in addition to the examples listed above. One way to add more features is to apply similar performance provisioning to processing blocks that also have discrete performance steps and are provisioned using utilization-based metrics. Even for the main subsystems, like the CPU and GPU, there are additional metrics that may be monitored, like the number of inputs/outputs (IOs) initiated, cache utilization, cache hits/miss rates, Dial on Demand Routing (DDR) traffic, number instances of certain types of load/store instructions, time consuming multiplication/division instructions, etc. which may improve accuracy of the model.

While “big cluster” and “little cluster” are mentioned as examples of ARM instructions, the various aspects are equally applicable to CPU instructions of non-ARM CPUs.

For servers, which receive power at all times (as compared to battery-powered devices), performance-first provisioning enables an incoming request to be processed fast as possible, which is most important for providing service to client devices. However, in mobile devices that are battery powered, consideration of battery power usage is more important that fast-as-possible processing. Thus, the various aspects adjust performance provisioning for requests to meets an acceptable processing rate targets that, though slower than performance-first provisioning, do not interfere with normal functioning of the mobile device or result in a user-perceptible in performance. A human user, for example, cannot really distinguish between 30 frames per second (FPS) and 60 FPS rendition on a mobile device screen. Thus, a performance-first strategy that renders 60 FPS results in a user experience that is no better than a power-first strategy that renders only 30 FPS from the user-experience prospective, while the battery life performance (which also contributes to the user experience) would be significantly improved.

Performance-first provisioning may also result in increased operating temperatures of the device SoCs, which leads to a reduction in the service life of mobile devices. Thus, a performance-first strategy in passively cooled mobile devices would add thermal stress to the system. In contrast, a power-first strategy only consumes enough power to meet the real performance needs of an application, thereby avoiding unnecessary heating and thermal aging of device components. A provisioning strategy that addresses the real provisioning needs of an application provides a balance between performance-first and power-first strategies, enabling a mobile device to deliver user-acceptable performance while avoiding unnecessary thermal aging of device components.

In various aspects, the work groups may be initially determined by evaluating the computing device metrics to obtain numerical values representing those computing device metrics, executing a polynomial function on the numerical values to produce computing device metric expressions, mapping the computing device metric expressions to an N-dimensional space in which “N” is defined by the computing device metrics, and determining each region bounded by the computing device metric expressions as a work group.

The various aspects may include a method of classifying types of work performed by software applications in order to provision each type of work for performance provisioning suitable for the work type (i.e., a work group). The type of work, or appropriate work group, may be classified using machine learning techniques trained on prior software application work groups.

The aspect methods may include creating a machine learning model using a combination of orthogonal system metrics (i.e., computing device metrics), training the models using known performance provisioning for work groups containing similar types of work, classifying new work items for various software applications into one or more work groups, and applying performance provisioning rules during the execution of those work items based on a work group to which the work item belongs. The various aspect methods may enable on-the-fly customizable performance provisioning by using dynamic classification of different work items of an executing software application.

Some aspect methods may include creating a machine learning model using a combination of orthogonal system metrics (i.e., computing device metrics). For example, the work group classification models may be built using machine learning techniques as applied to multiple system metrics of a computing device. The metrics may include graphical processing unit (GPU) frequency range, central processing unit (CPU) frequency for a cluster of little CPUs, CPU frequency for a cluster of big CPUs, CPU utilization of the cluster of little CPUs, CPU utilization of the cluster of big CPUs, and advanced RISC machine (ARM) instructions. Many more features or classes may be used in various aspects. Each of the possible classes may be further correlated (or compared) to GPU usage and ARM instruction calls. These metrics may be evaluated to obtain numerical values, which are then subjected to a polynomial function. The resulting polynomial expressions (e.g., system metric expressions) may be mapped to n N-dimensional graph in which N is defined by the number of orthogonal system metrics, and as such, define borders between classification groups. The classification groups may be spatial regions within an N-dimensional space in which the boundaries are defined by “N” equations.

Some aspect methods may include training the models using known performance provisioning for types of work. For example, the computing device may store sets of performance provisioning rules associated with each defined region (e.g., each work group) within the N-dimensional space. Thus, all work items mapped to a specific region may be considered to have similar performance provisioning needs.

Some aspect methods may include classifying new work items for various software applications into different work groups or work classes using the trained work group classification models. For example, as new software applications are installed and executed on the computing device, the system metrics (i.e., computing device metrics) associated with the software application's execution may be evaluated. The metrics for a given software application work item may be mapped to the N-dimensional space containing the classifier models, which are the several polynomial equations defining regions within the N-dimensional space.

Some aspect methods may include applying performance provisioning rules to work items of different work group or work classes within the same software application. For example, once a work item (or type of work item) is classified, the computing device may access stored performance provisioning rules associated with the work group, and apply these performance provisional rules to the work item.

The various aspects may use machine learning techniques to classify work items into work groups that share common performance provisioning characteristics. The various aspects may assign performance provisioning rules based on work type classification. Various aspects may use computing device metrics of an executing software application to determine the performance provisioning needs of its different types of work, and may categorize work groups including those work types as having common performance provisioning needs. The various aspects may extend the battery life of a computing device by implementing dynamic performance provisioning to work items of a software application. The various aspects may perform predictive behavior classification of software application work items prior to execution by an application. Various aspects may determine a classification of a work item based on graphical processing unit frequency, ARM instructions, little CPU cluster frequency, and big CPU frequency observed by the computing device during execution of the work item.

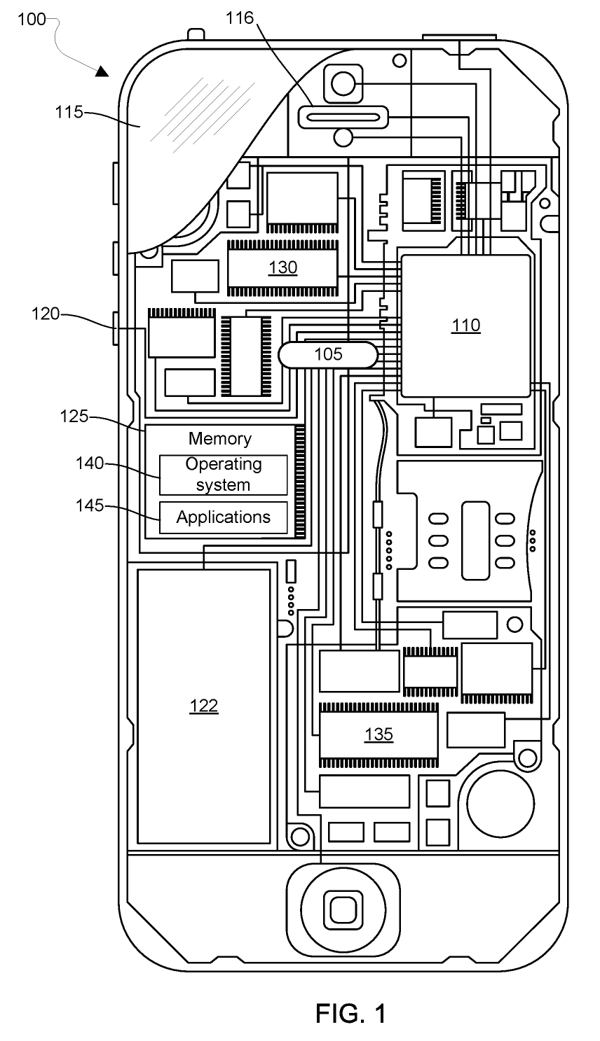

FIG. 1 illustrates a computing device 100 suitable for use with various aspects. The computing device 100 is shown including hardware elements that can be electrically coupled via a bus 105 (or may otherwise be in communication, as appropriate). The hardware elements may include one or more processor(s) 110, including, without limitation, one or more general-purpose processors and/or one or more special-purpose processors (such as digital signal processing chips, graphics acceleration processors, and/or the like). The hardware elements may further include one or more input devices, which may include a touchscreen 115. The hardware elements may further include, without limitation, one or more cameras, one or more digital video recorders, a mouse, a keyboard, a keypad, a microphone and/or the like. The hardware elements may further include one or more output devices, which include, without limitation, an interface 120 (e.g., a universal serial bus (USB)) for coupling to external output devices, a display device, a speaker 116, a printer, and/or the like.

The computing device 100 may further include (and/or be in communication with) one or more non-transitory storage devices such as non-volatile memory 125, which may include, without limitation, local and/or network accessible storage, such as a disk drive, a drive array, an optical storage device, solid-state storage device such as a random access memory (RAM) and/or a read-only memory (ROM), which can be programmable, flash-updateable, and/or the like. Such storage devices may be configured to implement any appropriate data stores, including without limitation, various file systems, database structures, and/or the like.

The computing device 100 may also include a communications subsystem 130, which may include, without limitation, a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein.

The computing device (e.g., 100) may further include a volatile memory 135, which may include a RAM or ROM device as described above. The memory 135 may store processor-executable-instructions in the form of an operating system 140 and application software (applications) 145, as well as data supporting the execution of the operating system 140 and applications 145.

The computing device 100 may include a power source 122 coupled to the processor 110, such as a disposable or rechargeable battery. The rechargeable battery may also be coupled to the peripheral device connection port to receive a charging current from a source external to the computing device 100.

The computing device 100 may be a mobile computing device or a non-mobile computing device, and may have wireless and/or wired network connections.

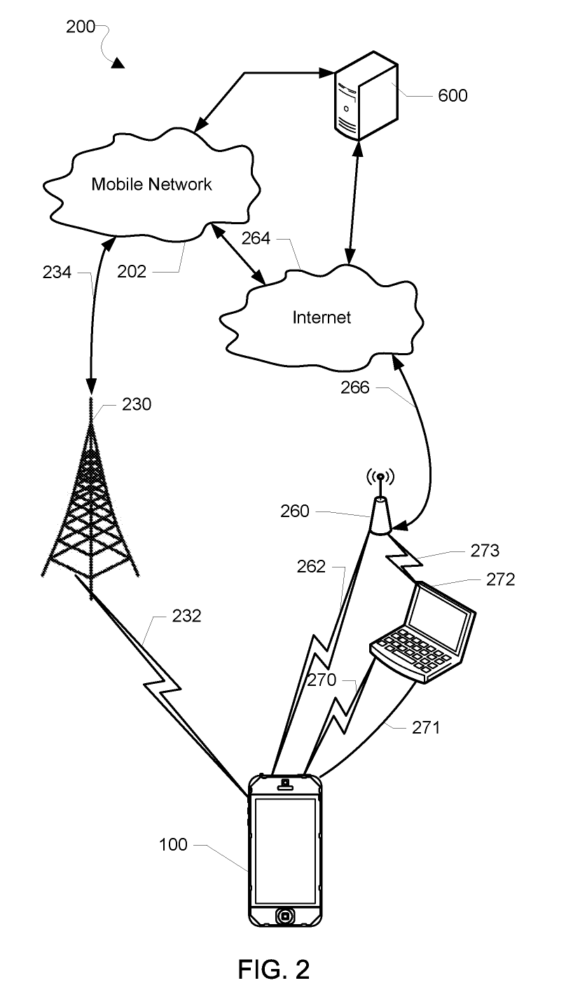

Various aspects may be implemented within a variety of communications systems 200, an example of which is illustrated in FIG. 2. A mobile network 202 typically includes a plurality of cellular base stations (e.g., a first base station 230. The network 202 may also be referred to by those of skill in the art as access networks, radio access networks, base station subsystems (BSSs), Universal Mobile Telecommunications Systems (UMTS) Terrestrial Radio Access Networks (UTRANs), etc. The network 202 may use the same or different wireless interface technologies and/or physical layers. In an aspect, the base stations 230 may be controlled by one or more base station controllers (BSCs). Alternate network configurations may also be used and the aspects are not limited to the configuration illustrated.

A first computing device 100 may be in communications with the mobile network 202 through a cellular connection 232 to the first base station 230. The first base station 230 may be in communications with the mobile network 202 over a wired connection 234.

The cellular connection 232 may be made through two-way wireless communications links, such as Global System for Mobile Communications (GSM), UMTS (e.g., Long Term Evolution (LTE)), Frequency Division Multiple Access (FDMA), Time Division Multiple Access (TDMA), Code Division Multiple Access (CDMA) (e.g., CDMA 1100 1×), WCDMA, Personal Communications (PCS), Third Generation (3G), Fourth Generation (4G), Fifth Generation (5G), or other mobile communications technologies. In various aspects, the computing device 100 may access network 202 after camping on cells managed by the base station 230.

In some aspects, the first computing device 100 may establish a wireless connection 262 with a wireless access point 260, such as over a wireless local area network (WLAN) connection (e.g., a Wi-Fi connection). In some aspects, the first computing device 100 may establish a wireless connection 270 (e.g., a personal area network connection, such as a Bluetooth connection) and/or wired connection 271 (e.g., a USB connection) with a second computing device 272.

The second computing device 262 may be configured to establish a wireless connection 273 with the wireless access point 260, such as over a WLAN connection (e.g., a Wi-Fi connection). The wireless access point 260 may be configured to connect to the Internet 264 or another network over a wired connection 266, such as via one or more modem and router. Incoming and outgoing communications may be routed across the Internet 264 to/from the computing device 100 via the connections 262, 270, and/or 271.

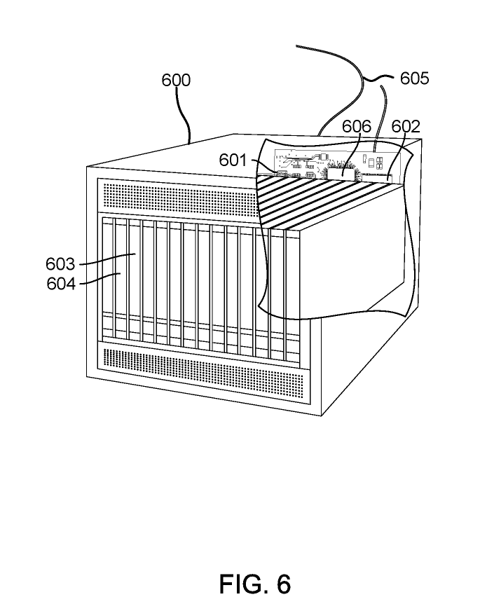

In some aspects, the computing device 100 may utilize connections 262, 270, and/or 271 to transmit and receive information from a remote server 600, as discussed in further detail in FIG. 6.

While FIG. 2 shows one mobile device connected to a second computing device 262, the various aspects are equally applicable to multiple mobile devices connected to a remote server or the cloud, performing simultaneous updates of a global table/database (key/value storage) of applications and their optimal provisioning settings. Such a global lookup table or database may be stored in a server for crowd-sourcing performance provisioning according to various aspects.

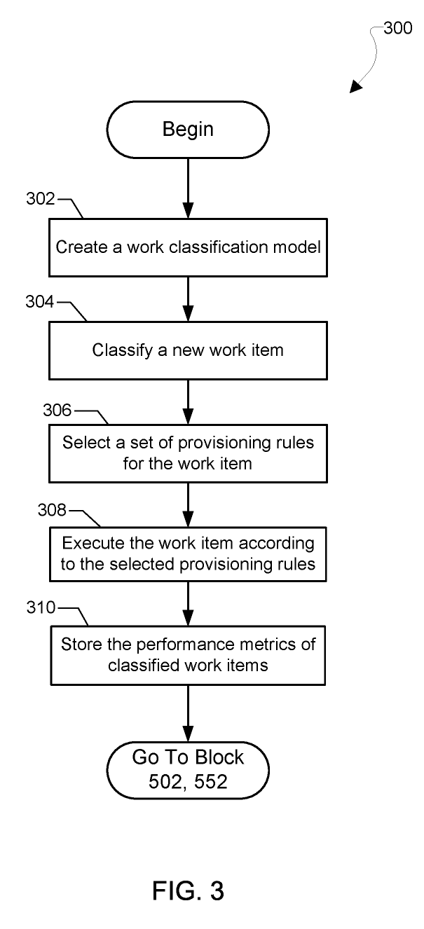

FIG. 3 illustrates a process flow diagram of a method 300 for performance provisioning of work processing in any application in accordance with various aspects. The method 300 may be implemented on a computing device (e.g., 100) and carried out by a processor (e.g., 110) in communication with the communications subsystem (e.g., 130), and the memory (e.g., 125).

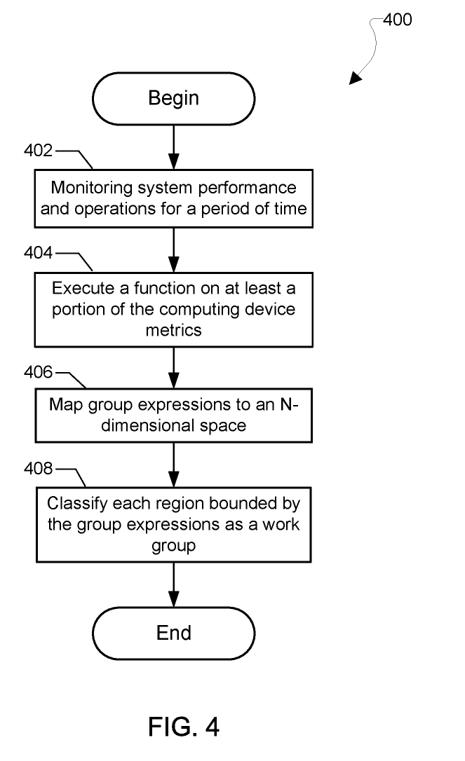

In block 302, the processor (e.g., 110) of the computing device (e.g., 100) may create a work classification model based at least in part on computing device metrics observed or calculated by the processor during normal operation. As is discussed in greater detail with reference to FIGS. 4, 7 and 8, the processor may create a base work classification model to classify new software applications into work groups.

In block 304, the processor may classify a new work item for a software application into a work group using the work classification model. Software applications may be allowed to run for a duration during which computing device metrics may be monitored. The observed computing device metrics may be mapped to an N-dimensional space in which N is the number of observed computing device metrics. The region of the N-dimensional space to which the computing device metrics are mapped may be associated with a work group. The software application, or a work item of that software application, may thus be classified as belonging to the work group associated with the relevant region of the N-dimensional space.

In block 306, the processor may select a set of provisioning rules for the work item based, at least in part, on the work group to which the work item was classified. The computing device may have a number of performance provisioning rules stored in memory (e/g/. 125). The performance provisioning rules may include order of execution, hardware optimization, and the like. During the creation of the work classification model, each work group may be associated with one or more sets of provisioning rules. Once a software application or its respective work items are properly classified into a work group, the processor (e.g., 110) may access a data structure containing the association between provisioning rules and the work groups. The processor (e.g., 110) may use the data structure to select one or more sets of provisioning rules associated with the work group to which the software application or work item is classified.

In block 308, the processor may execute the work item according to the selected provisioning rules. The selected provisioning rules may be applied to the software application or its work item and executed accordingly. For example, if the provisioning rules indicate that the software application or work item is light weight and should only be operated a low GPU frequencies, then GPU processing may be adjusted accordingly to reduce unnecessary processing.

In block 310, the processor may store performance metrics of classified work items in a memory (e.g., 125). The performance metrics may be the same metrics as the computing device metrics; however, the performance device metrics may be observed for an already classified software application or work item. Performance metrics may be used to determine whether a software application or work item is obtaining proper performance provisioning. The collective performance metrics of several software applications or work items may be used by the computing device (e.g., 100) to determine whether the work classifier model is properly classifying the performance provisioning needs of new software applications and work items.

FIG. 4 illustrates a process flow diagram of a method 400 for creating work groups of a work classification model for use in performance provisioning of work processing in any application in accordance with various aspects. The method 400 may be implemented on a computing device (e.g., 100) and carried out by a processor (e.g., 110) in communication with the communications subsystem (e.g., 130), and the memory (e.g., 125).

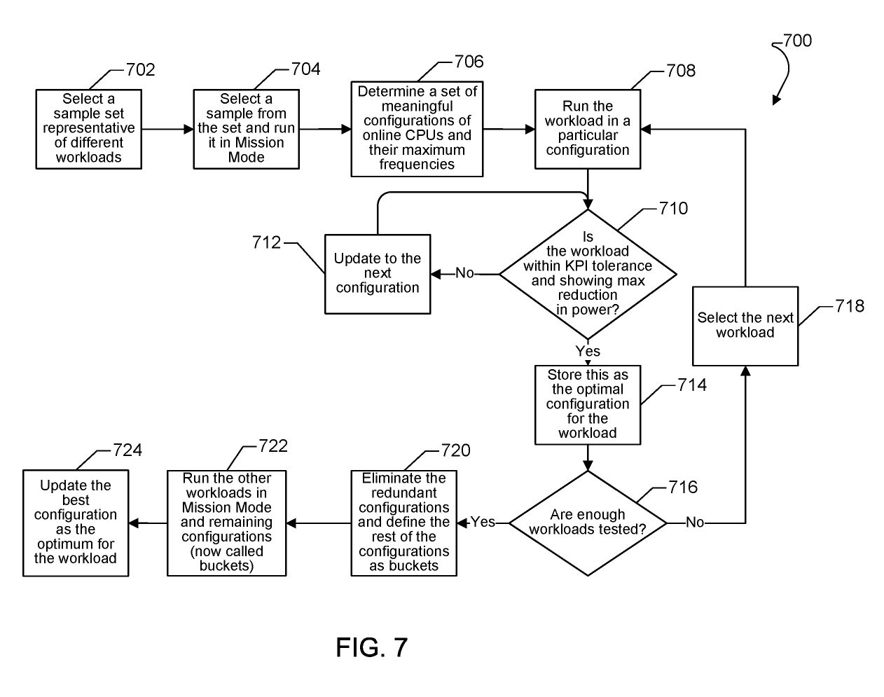

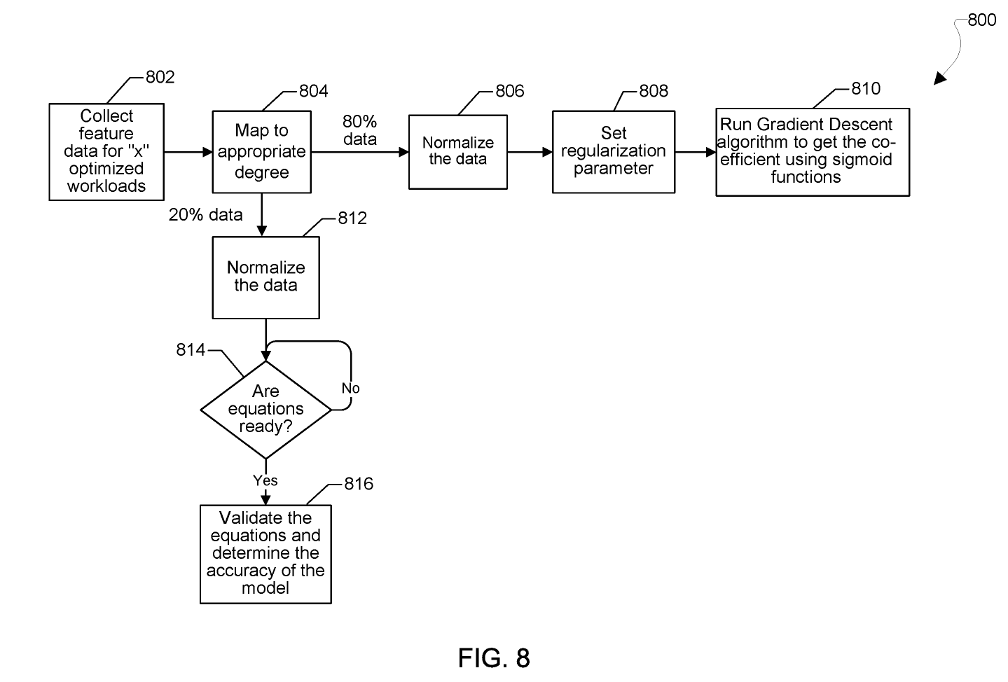

In block 402, the processor (e.g., 110) of the computing device (e.g., 100) may monitor system performance and operations for a period of time to obtain the computing device metrics. Various aspects may include the processor (e.g., 110) observing the hardware performance of the SoC during an initial evaluation period, such as 10-45 minutes. The initial evaluation period may provide the computing device (e.g., 100) with an opportunity to execute a number of software applications, and to observe and record computing device metrics for the execution of the applications. Computing device metrics monitored during the initial evaluation period may include GPU Frequency Level/level range; CPU Frequency/frequency ranges—little Cluster; CPU Frequency/frequency ranges—big cluster; the number and nature of ARM Instructions; CPU Utilization—little cluster; and/or CPU Utilization—big cluster. In various aspects, the computing system metrics collected during the initial evaluation period may be compared and correlated, and may be stored in a data structure in memory (e.g. 125). The initial identification of testing features and training of the work classification model is discussed in greater detail with reference to FIGS. 7 and 8.

In various aspects, the number of processors utilized within a little CPU cluster, the number of processors utilized within a big CPU cluster, and the respective operating frequency ranges of both CPU clusters may be observed during the initial evaluation period. Frequency ranges may include a minimum through a maximum operating frequency for a particular combination of little CPU clusters and big CPU clusters. Identifying the operating ranges for the big and little CPU clusters may enable the computing device (e.g., 100) to more easily differentiate between types of software applications based on their performance provisioning needs. An example characterization of frequency ranges may include:
light weight: ˜1 GHz (Little), ˜850 MHz (Big)
medium weight: >1 GHz (Little), ˜1 GHz (Big)
heavy weight: >1 GHz (Little), >1 GHz (Big)

Similarly, monitoring the utilization rates of the big and little CPU clusters of the SoC may further enable the computing device to differentiate between the types of applications based on their performance provisioning needs. An example characterization of CPU cluster utilization may be:
light weight: >30% (Little), ˜0% (Big)
medium weight: 20%-40% (Little), 5%-10% (Big)
heavy weight: ˜20% (Little), >15% (Big)

These CPU frequency and utilization ranges may be highly hardware dependent and may need to be evaluated for each SoC model or reevaluated if the SoC of a computing device is changed.

In various aspects, the processor may observe GPU Frequency metrics. GPU frequency may be particularly important in software applications requiring significant graphical processing workload such as games, or video editing. Games requiring large amounts of general processing power may also require significant GPU resources. An example GPU may have operating frequencies ranging from 266 MHz to 600 MHz. The operating frequencies may be divided into levels for the purposes of categorization and classification. For example, the GPU operating frequencies may be divided into three levels including:

a. Level 1—266 MHz

b. Level 2—300 MHz

c. Level 3—432 MHz, 480 MHz, 550 MHz, 600 MHz

Heavy weight software applications may use GPU frequencies of more than 400 MHz and hence fall in Level 3. Medium weight software applications may use GPU frequencies 266 MHz and 300 MHz, and therefore may fall into one or more of Level 1 and Level 3. Light weight software applications may use 266 MHz, and thus fall very close to Level 1. Like CPU utilization and frequency metrics, the GPU frequency is highly hardware dependent, and may need to be evaluated or reevaluated as for each new GPU.

In various aspects, the processor may observe the number and nature of ARM instructions used during the initial evaluation period. That is, the inclusion of ARM instruction counts into the observed computing device metrics may increase the overall accuracy of the resultant work classification model. ARM instructions may provide a strong indicator of CPU pipeline load. For example, a while (1) loop running on a single CPU may use 100 CPU Utilizations but may have a considerably smaller number of ARM instructions when compared to Dhrystone which also uses 100 CPU Utilizations at same frequency. Heavier software applications may tend to use larger ARM instruction counts when compared to other software applications (e.g., >1200M). Lighter software applications may use fewer ARM instruction counts when compared to other software applications (e.g., <800M). Medium software applications may use a number of ARM instructions lying between the heavier and lighter weight software applications (e.g., between 800M-1200M). The ARM instructions count may be more or less independent of the hardware design of the device.

Thus, the processor may determine that for each observed computing device behavior there are several categories, classifications, and/or variations of behavior of software application for that behavior. Determining the number of possible permutations of behavior categories may provide the computing device (e.g., 100) with a set of work groups into which future software applications may be classified. That is, each possible combination of behaviors may represent a single work group.

In block 404, the processor may execute a function on at least a portion of the computing device metrics to produce group expressions. A second order polynomial expression (i.e., a function) may be generated for each of the possible combinations of behaviors/computing device metrics. The function may be represented by:

$${h}_{θ} ( x ) = g ( {θ}^{T} x )$$

$$g ( z ) = \frac{1}{1 + {e}^{- z}}$$

Below are some non-limiting examples of θ values for θᵢxᵢ; iε (0,27):

| | θ₍₀₎ | θ₍₁₎ | θ₍₂₎ | θ₍₃₎ | θ₍₄₎ | θ₍₅₎ | θ₍₆₎ | θ₍₇₎ |
|---|---|---|---|---|---|---|---|---|
| h₍₁₎(x) | −8.1773 | 0.3370 | −0.2541 | 0.4752 | 0.0199 | −0.2465 | 0.0572 | 0.3653 |
| h₍₂₎(x) | −15.6700 | 0.0000 | 0.0002 | 0.0005 | −0.0002 | 0.0001 | −0.0001 | 0.0000 |
| h₍₃₎(x) | −8.8299 | −0.0294 | −0.7815 | −0.2583 | 0.5056 | −1.0502 | 0.4065 | −0.1460 |
| h₍₄₎(x) | −11.1130 | 0.2966 | −0.0289 | 0.0441 | −0.1377 | 0.4897 | 0.1947 | 0.4215 |
| h₍₅₎(x) | −3.8186 | −0.4065 | −0.4533 | 1.2078 | −0.2928 | −0.0434 | 0.5510 | −1.0711 |
| h₍₆₎(x) | −2.4729 | 0.3264 | 0.6157 | −0.2970 | 0.4135 | 0.0844 | 0.0048 | 0.0907 |
| h₍₇₎(x) | −3.4264 | 0.1062 | −0.0464 | −0.5270 | 0.3389 | 0.4711 | 0.8608 | −0.4193 |
| h₍₈₎(x) | −7.2193 | 0.1747 | 0.9223 | −0.1132 | 0.0041 | 0.2924 | −0.0528 | 0.0823 |
| h₍₉₎(x) | −5.8076 | −0.0127 | −0.5355 | −0.1374 | 0.3029 | −0.1091 | −0.3887 | −0.0124 |
| h₍₁₀₎(x) | −2.7816 | −0.6937 | 1.0313 | −0.3202 | 0.1792 | −0.0185 | −0.0421 | −0.4518 |
| h₍₁₁₎(x) | −6.8558 | −0.2298 | −0.3094 | −0.2939 | −0.0489 | 1.4360 | −0.5073 | −0.2169 |
| h₍₁₂₎(x) | −5.3836 | −0.0230 | 0.0317 | −0.3241 | −0.3996 | −0.5074 | −0.5665 | −0.0121 |

| | θ₍₈₎ | θ₍₉₎ | θ₍₁₀₎ | θ₍₁₁₎ | θ₍₁₂₎ | θ₍₁₃₎ | θ₍₁₄₎ |
|---|---|---|---|---|---|---|---|
| h₍₁₎(x) | 0.1295 | 0.5198 | 0.2247 | 0.0055 | 0.3268 | −0.2385 | 0.1752 |
| h₍₂₎(x) | −0.0001 | 0.0002 | −0.0001 | −0.0001 | 0.0001 | 0.0002 | 0.0005 |
| h₍₃₎(x) | −0.1666 | −0.1788 | 0.1419 | −0.3015 | 0.1644 | −0.6607 | −0.8393 |
| h₍₄₎(x) | 0.3001 | 0.2365 | 0.1033 | 0.6891 | 0.4207 | −0.0459 | 0.0604 |
| h₍₅₎(x) | 0.1517 | −0.9646 | 0.0269 | 0.3085 | −0.9270 | −0.4439 | 1.1172 |
| h₍₆₎(x) | 0.3042 | 0.0608 | −0.3170 | −0.0504 | −0.4262 | 0.3338 | 0.2513 |
| h₍₇₎(x) | −0.0401 | −0.2850 | −0.1902 | 0.0887 | 0.3658 | −0.3421 | −0.8308 |
| h₍₈₎(x) | 0.4448 | −0.0172 | 0.4085 | −0.5580 | 0.0252 | 1.0951 | 0.5565 |
| h₍₉₎(x) | −0.1193 | −0.0384 | 0.0926 | −0.0370 | −0.2235 | −0.5387 | −0.5020 |
| h₍₁₀₎(x) | −0.4400 | −0.5156 | −0.4413 | −0.5346 | −0.4445 | 0.8589 | 0.5867 |
| h₍₁₁₎(x) | −0.3065 | −0.2058 | −0.1599 | 0.1533 | −0.3300 | −0.7551 | −0.6117 |
| h₍₁₂₎(x) | −0.0101 | −0.0753 | −0.1525 | −0.1494 | −0.3067 | −0.0635 | −0.3069 |

| | θ₍₁₅₎ | θ₍₁₆₎ | θ₍₁₇₎ | θ₍₁₈₎ | θ₍₁₉₎ | θ₍₂₀₎ | θ₍₂₁₎ | θ₍₂₂₎ | θ₍₂₃₎ | ₂₄₎θ₍ | θ₍₂₅₎ | θ₍₂₆₎ | θ₍₂₇₎ |
|---|---|---|---|---|---|---|---|---|---|---|---|---|---|
| h₍₁₎(x) | −0.0945 | −0.2458 | −0.0136 | 0.5531 | 0.2359 | −0.0172 | 0.2137 | −0.0115 | −0.1359 | 0.0945 | −0.2358 | −0.0555 | 0.0641 |
| h₍₂₎(x) | −0.0001 | 0.0001 | −0.0002 | 0.0005 | 0.0000 | 0.0003 | 0.0001 | −0.0002 | −0.0001 | −0.0002 | 0.0000 | −0.0002 | 0.0000 |
| h₍₃₎(x) | 0.0882 | −0.7850 | 0.1599 | −0.2822 | 0.3002 | −1.1243 | 0.1872 | 0.4392 | −0.3113 | 0.4600 | −0.7349 | −0.1694 | 0.2147 |
| h₍₄₎(x) | −0.1581 | 0.3321 | 0.2554 | 0.0147 | −0.1099 | 0.5707 | 0.1692 | −0.2336 | 0.1387 | 0.1665 | 0.6418 | 0.5016 | 0.1536 |
| h₍₅₎(x) | 0.2313 | −0.1795 | 0.4491 | 0.5568 | −0.3912 | 0.9497 | 0.5244 | −0.0357 | 0.6255 | −0.6464 | −0.1099 | 0.4465 | −0.8516 |
| h₍₆₎(x) | 0.6242 | −0.0001 | −0.0487 | −0.3975 | −0.0163 | −0.2563 | 0.1188 | −0.1302 | 0.2674 | −1.1794 | −0.4526 | −0.2122 | 2.3620 |
| h₍₇₎(x) | 0.2115 | 0.0757 | 1.1029 | −0.5387 | −0.1476 | −0.4764 | 0.1238 | −0.4422 | 0.0105 | 0.2114 | 0.3779 | 1.3040 | −1.8345 |
| h₍₈₎(x) | 0.3507 | 0.7205 | 0.0051 | −0.1003 | 0.0316 | −0.1104 | −0.1316 | −0.0741 | −0.1443 | 0.0696 | 0.1500 | −0.4688 | −0.1312 |
| h₍₉₎(x) | 0.0935 | −0.2860 | −0.3580 | −0.1158 | 0.1271 | −0.1624 | −0.3277 | −0.0763 | 0.1277 | −0.3937 | −0.1582 | −0.3126 | −0.2762 |
| h₍₁₀₎(x) | −0.3482 | −0.2811 | 0.0925 | −0.4255 | 0.1769 | 0.2334 | −0.3815 | 0.3473 | −0.1721 | 0.9752 | −1.3452 | 0.6533 | −1.0091 |
| h₍₁₁₎(x) | −0.4660 | 0.3765 | −0.6838 | −0.2222 | −0.1436 | 0.8407 | −0.3850 | −0.2714 | 0.0443 | −0.4591 | 1.0457 | −0.7725 | −0.0994 |
| h₍₁₂₎(x) | −0.0799 | −0.3946 | −0.5838 | −0.2437 | −0.3482 | −0.6047 | −0.4383 | 0.1199 | −0.2042 | −0.4229 | −0.5303 | −0.5204 | −0.2855 |

The foregoing examples of metrics implemented in blocks 402 and 404 are not intended to be limiting. Many more features may be evaluated and considered to improve the classification model according to various aspects.

In block 406, the processor may map the group expressions to an N-dimensional space. The number of parameters in the group expressions may define the size of the N-dimensional space. Thus, the number of behaviors/computing device metrics observed may be a number “N”. An N-dimensional space may be a mathematical representation in which each computing device metric represents a single dimension. The group expressions may be mapped to the N-dimensional space thereby creating regions of the N-dimensional space delineated by boundaries of group expressions.

In block 408, the processor may classify each region bounded by the group expressions as a work group. The processor may detect regions bounded by the group expressions and may classify each of these regions as associated with a particular work group. Any future software application having computing device metrics mapped within one of the identified regions is classified as belonging to the associated work group.

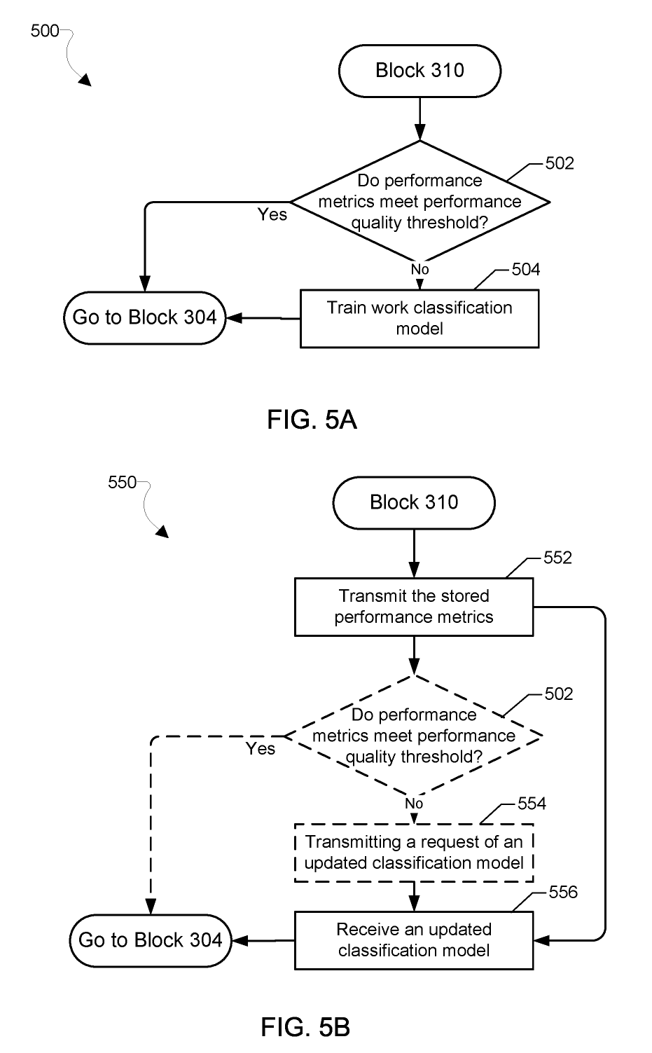

FIGS. 5A-5B illustrate process flow diagrams of methods 500, 550 for updating or retraining a work classification model for use in performance provisioning of work processing in any application in accordance with various aspects. The methods 500, 550 may be implemented on a computing device (e.g., 100) and carried out by a processor (e.g., 110) in communication with the communications subsystem (e.g., 130), and the memory (e.g., 125).

Referring to FIG. 5A, in determination block 502, the processor (e.g., 110) of the computing device (e.g., 100) may determine whether the stored performance metrics meet a performance quality threshold. The computing device may have one or more performance quality thresholds stored in memory (e.g. 125). The performance quality thresholds may be numerical values above or below which the respective performance metric is considered to be unacceptable. In determination block 502, the processor may compare a single performance metric of multiple software applications or work items to determine whether a specific performance metric is being accurately addressed by the work classifier model. For example, the computing device may examine operating frequencies of the little CPU cluster across multiple executions of work items, and determine that this performance metric is or is not meeting performance quality thresholds.

In various aspects, the processor may examine all performance metrics of several software applications and/or work items collectively, and may determine whether the error rate, taken as a whole, meets a performance quality threshold.

In response to determining that the stored performance metrics do not meet the performance quality threshold (i.e., determination block 502=“No”), the processor may train the work classification model in block 504. The computing device may re-train the work classification model utilizing just a single performance metric if only that performance metric fails to meet the performance quality threshold. In various aspects, the entire work classification model may be retained using all collected performance metrics from the classified software applications and work items. The result may be an updated work classification model.

In response to determining that the stored performance metrics do meet the performance quality threshold (i.e., determination block 502=“Yes”), the processor may return to block 304 of the method 300 to continue classifying work items of software applications. Thus, if the stored performance metrics meet a threshold quality threshold, the work classification model may be assumed to be accurately classifying new work items, and as a consequence, proper provisioning rules are being applied.

FIG. 5B illustrates a client-server aspect of work classification model updating. Such aspects provide methods for crowd-sourcing of performance metrics and the updating of the work classification model based on larger pools of gathered performance metrics. FIG. 5B provides a non-limiting example of how crowdsourcing may be used to optimize performance-metrics while avoiding duplication of steps for applications whose ‘work group’ has been identified on a similar device from another user.

In block 552, the processor (e.g., 110) of the computing device (e.g., 100) may transmit the stored performance metrics to a remote server, such as via by a transceiver of the mobile device. The remote server may aggregate performance metrics from a large number of computing devices and may store the data in association with specific performance metrics or specifics and/or work groups.

In a further aspect, users may provide an input that sets or annotates a performance indicator to improve workload classification model accuracy. In such aspects, a mobile device user may occasionally provide an input (e.g., via a graphical user interface) to manually annotate performance of an application. Based on this feedback, the processor may try higher performance groups for the user and then use the new workgroup to retrain the model.

In block 556, the processor may receive an updated classifier model from the remote server. In some aspects, a remote server may automatically send the computing device an updated work classification model. The remote server may send the updated work classification model as it becomes available or in response to receiving performance metrics form the computing device. In such aspects, the server may retrain the work classification model and may send only the updated work classification model to the computing device. Thus, the computing device may only be responsible for classifying applications and storing performance metrics, rather than retaining the work classification model.

Optionally, in determination block 502, the processor may determine whether the stored performance metrics meet a performance quality threshold. This determination may proceed in the manner described for block 502 with reference to FIG. 5A.

In response to determining that the stored performance metrics do meet the performance quality threshold (i.e., determination block 502=“Yes”), the processor may return to block 304 of method 300 to continue classifying work items of software applications.

In response to determining that the stored performance metrics do not meet a performance quality threshold (i.e., determination block 502=“No”), the processor may transmit a request for an updated classification model in block 554. The computing device (e.g., 100) may then receive an updated work classification model in block 556.

Portions of the aspect methods may be accomplished in client-server architecture with some of the processing occurring in a server, such as maintaining databases of normal operational behaviors, which may be accessed by a mobile device processor while executing the aspect methods. Such aspects may be implemented on any of a variety of commercially available server devices, such as the server 600 illustrated in FIG. 6. Such a server 600 typically includes a processor 601 coupled to volatile memory 602 and a large capacity nonvolatile memory, such as a disk drive 603. The server 600 may also include a floppy disc drive, compact disc (CD) or digital versatile disc (DVD) disc drive 604 coupled to the processor 601. The server 600 may also include network access ports 606 coupled to the processor 601 for establishing data connections with a network 605, such as a local area network coupled to other broadcast system computers and servers.

The processors 602, 601 may be any programmable microprocessor, microcomputer or multiple processor chip or chips that can be configured by software instructions (applications) to perform a variety of functions, including the functions of the various aspects described below. In some mobile devices, multiple processors 601 may be provided, such as one processor dedicated to wireless communication functions and one processor dedicated to running other applications. Typically, software applications may be stored in the internal memory 602, 603 before they are accessed and loaded into the processor 601. The processor 602, 601 may include internal memory sufficient to store the application software instructions.

Various aspects may include the selection of features to be monitored during work classification model generation based, at least in part, on a number of factors. Observed features provide an indication of the workload or resource strain on the various processing resources of the communications device 100.

Various aspects may include three categories of observed features. A particular observed feature may depend on the form factor or make of the computing device. For example, a tablet computing device displaying a plain white screen at 100% brightness may consume more battery power than a mobile communication device (e.g., a smartphone) displaying the same white screen. Such features are form-factor dependent. Some observed features may vary with the type or model of SoC, even if they are of the same form factor. For example, the utilization of a workload may vary among different SoC architectures. These features are SoC dependent (i.e., the features depend upon the specific type of SoC). Other features may vary from production run to production run, and from chip to chip within a given production run, even if the respective communications devices utilize the same model of SoC. For example, junction temperatures are highly dependent on leakage current of the circuits within the SoC and can vary largely among different chips of the same type of SoC. Features that vary from one SoC to the next within a production run of the same type/model of SoC are referred to as “silicon dependent.”

Features that are representative of workload similarly across various parts of the same SoC family (i.e., silicon independent features) may be good indicators of the processing workload of the SoC within the computing device, and therefore may be good features to incorporate into the machine learning model.

ARM instructions that are executing within a unit of time or that are pending in an execution cue may provide a good measure of the workload within a processing unit of an SoC within a computing device. This is because ARM instructions help to differentiate between two active threads on the basis of the number of instructions that are executed by the thread. Conversely, CPU utilization rates merely observe the number of threads executing on a processing unit and may not account for the actual work needed to process each thread. Further, ARM instructions are device-independent parameters. That is, the same thread executed on the same type of SoC architecture on another communications device will execute the same number of ARM instructions. This form-factor independence and silicon independence make ARM instructions a good indicator of the actual workload of a processing unit across different computing devices.

The workload within a processing unit may be associated with one or more key performance indicators (KPIs). Such KPIs may be continuously monitored and actions may be taken to ensure that the KPIs do not drop beyond a threshold value. There may be a reference value/threshold for each KPI for the particular workload determined by the KPI's operation in a mission mode settings. Example types of workload and associated KPIs are listed in the following table.

| Type of Workload | Common KPIs |
|---|---|
| Games | Frames per second (FPS) |
| Camera-intensive applications | Camera-preview-FPS |
| Scroll-intensive applications (e.g., | FPS, Data-rate |
| Blogs, social media) | |
| Videos | FPS, Data-rate |

During initial generation of the work classification model, each workload may be run in different configurations and the corresponding power and FPS may be monitored. Various KPIs may be monitored actions taken to ensure that performance is balanced and some KPI do not suffer in order to improve performance of others. A number of test runs of a workload in different configurations may be performed in order to identify a configuration that yields power savings without producing a drastic decline in KPI that may impact the user experience. For example, in a series of workload configuration benchmark tests, a baseline frames per second (FPS) value may be 56.83 FPS with a performance threshold of 5%-10%. That is, only workload configurations that result in a 5-10% of 56.83 drop in FPS or less may be considered suitable for use in the work classification model. A workload configuration that saved 28.88% power may not be an ideal configuration if the FPS dropped by 20.84. A better workload configuration may be one that produces only a modest decrease in FPS, such as ˜2.5 that is unnoticeable to the human eye, with more conservative power savings.

Because a workload configuration for use in the work classification model may be selected based on numerous benchmark tests of feature data, as opposed to current allocation based on instantaneous data only, there is minimal chance that future workloads of a similar nature will demand a very different amount of resources. Thus, the selected configurations may be used to accurately classify the work items of future applications.

FIG. 7 illustrates a process flow diagram of a method 700 for initial generation of a work classification model for use in performance provisioning of work processing in any application in accordance with various aspects. The method 700 includes operations for selecting workload configurations for use in a work classification model. The method 700 may be implemented on a computing device (e.g., 100) and carried out by a processor (e.g., 110) in communication with the communications subsystem (e.g., 130), and the memory (e.g., 125).

In block 702, the processor (e.g., 110) of the computing device (e.g., 100) may select a sample set representative of different workloads. The sample set may contain applications of different type or requiring different processing resources.

In block 704, the processor may select a workload from the sample set and may execute the selected workload in a mission mode. The mission mode may be a test or standard mode in which the application is executed under normal to strenuous use conditions.

In block 706, the processor may identify a set of configurations. Each configuration may include a combination of big and little clusters of CPUs and associated frequency ranges for each CPU. For each configuration, a respective number of big and little CPU cluster components may be utilized at the specified frequency ranges. Each configuration may represent a future performance provisioning configuration.

In block 708, the processor may run the same sample for each of the identified configurations. By running the workload sample over numerous executions, the processor may be able to determine average performance metrics and ensure repeatability of results.

In determination block 710, the processor may determine whether or not the KPI of the execution workload is within a tolerance level and showing maximum power reduction. The KPI tolerance may be the acceptable performance range for a particular type of workload. For example, the KPI tolerance may be a minimum frame rate or latency rate. The processor may compare the execution metrics resulting from running the workload in the given performance provisioning configuration with the results of previous executions of the workload under different configurations.

In response to determining that the KPI of the execution workload is not within a tolerance level and/or not showing maximum power reduction (i.e., determination block 710=“No”), the computing device may in determination block 712, run the workload in another configuration.

In response to determining that the KPI of the execution workload is within a tolerance level and/or showing maximum power reduction (i.e., determination block 710=“Yes”), the processor may in block 714, store the current configuration as the optimal configuration for the workload. That is, if the KPI tolerance is acceptable, and the result of comparing the power consumption metrics against the power consumption metrics of previous configurations, indicate that the current power reduction is a maximum, then the computing device may store the current configuration.

In determination block 716, the processor may determine whether or not a sufficient number of workloads have been tested. A suitable sample size must be tested in order to ensure that the results of executing the workloads using any given configuration accurately represents the workload's performance provisioning needs.

In response to determining that a sufficient number of workloads have not been tested (i.e., determination block 716=“No”), the computing device may select a new sample workload in block 718.

In response to determining that a sufficient number of workloads have been tested (i.e., determination block 716=“Yes”), the processor may eliminate any redundant configurations and label the remaining configurations as work groups/buckets) in block 720.

In block 722, the processor may execute additional workloads using the identified work groups (buckets). The computing device may run other workloads of the same type in mission mode (e.g., standard or normal operation mode). The computing device may compare the results of each execution in order to identify the work group and associated configuration to which the workloads belong.

In block 724, the processor may update the best fit configuration for the workload. The computing device may use the identified work group and associated configuration as the best fit configuration for a workload and may replace the configuration stored in block 714 with the updated configuration.

The selected workload configuration data may be processed, normalized and passed to the model that generates equations that may be used for classification of future work items. The generation of work classification model equations is described with reference to FIG. 8.

The various aspects may implement supervised machine learning techniques to generate a set of classification model equations that may be used to categorize work items into classes based on their performance provisioning needs. In a supervised machine learning scheme, the work classification model may be trained on a given set of known inputs and their corresponding outputs, such as the sample workloads and identified acceptable performance ranges. Examples of machine learning algorithms suitable for use with the various aspects includes multinomial logistical regression, recursive neural networks, support vector machines, etc.

Multinomial logistic regression is a supervised machine learning algorithm that generates equations that may be used to classify an input into a particular class. The work classification model may be derived using multinomial logistical regression. The work classification model may be an N-dimensional polynomial representing “M” features (e.g., ARM instructions, GPU utilization, etc.). The polynomial may be of n^{th} degree such that “N=^{M}Cₙ+2m+1”. As discussed with reference to FIGS. 3 and 4, these equations demarcate a region in the N-dimensional space

To reduce biasing of equations, all monitored features may be normalized to the same scale or order of magnitude. Normalization may ensure that the regions enclosed by the equations of the work classification model are neither too narrow nor too broad, and no individual feature dominates the equation.

Both regularization and degree of the features are used to prevent over-fitting a curve through the training data points. Regularization introduces a type of “penalty” when a particular feature is influencing the curve too much. The degree of the features used determines the number of times the curve can change direction. Generally, a low degree may not allow the curve to change directions again and again to fit each point in the training dataset. False positives and false negatives are not detected in an over-fit curve, hence the boundaries become unreal.

In various aspects, equations may be regularized to reduce the risk of over-fitting. Ridge regression techniques may be utilized to prevent over-fitting of curves, by adjusting coefficients in the N^{th} degree polynomial. A gradient descent technique may be implemented for several iterations until the equations stabilize in order to ensure the correct minimum is obtained and the cost function is minimized. An appropriate degree (2^{nd} degree) of the features is used to avoid over-fitting of the curves to pass through each data point. A sigmoid calculation in conjunction with the 2^{nd} degree of features allows the regional boundaries represented by the work classification model equations to be curves rather than straight lines. This may enable more accurate representation of a region shape and is highly suitable for discrete classification.

FIG. 8 illustrates a process flow diagram of a method 800 for training a work classification model for use in performance provisioning of work processing in any application in accordance with various aspects. The method 800 includes operations for calculating the work classification model equations using the acceptable ranges of performance and associated workloads. The method 800 may be implemented on a computing device (e.g., 100) and carried out by a processor (e.g., 110) in communication with the communications subsystem (e.g., 130), and the memory (e.g., 125).

In block 802, the processor (e.g., 110) of the computing device (e.g., 100) may collect the feature data determined during the method 700. The feature data may be the acceptable ranges of performance for each of the monitored features (i.e., ARM instructions, CPU utilization, GPU utilization and paren.

In block 804, the processor may map the feature data to an N-dimensional space as discussed in greater detail with reference to FIG. 4.

In block 806, the processor may normalize about 80% of the feature data (i.e., the acceptable ranges of performance determined during the 700). This may normalization operation may cluster feature data and reduce outliers.

In block 808, processor may calculate regularization parameters for the feature data.

In block 810, the processor may execute multiple iterations of a gradient descent function in order to minimize the normalized and regularized feature data. The processor may further execute a sigmoidal function on the minimized data to obtain the color patients for the work classification model equations.

In block 812, the processor may normalize the remaining 20% of the feature data (i.e., the acceptable ranges of performance calculated in method 700). The normalized data may be passed to the machine learning algorithm as input to generate work classification model equations. The coefficients calculated in block 810 may be used in the duration of the model equations.

In determination block 814, the processor may determine whether equations have been properly derived and are ready for testing.

In response to determining that the equations are ready for testing (i.e., determination block 814=“yes”), the processor may validate the equation and test their accuracy on sample workloads in block 816. The processor may use collect feature data for optimized work of workloads from the initial sample for which the proper classification is known, and may execute the work classification model in order to ensure that the results matches the known classification.

In response to determining that the equations are not ready (i.e., determination block 814=“No”), the processor may continue executing machine learning algorithms and determining whether the equations are ready in determination block 814.

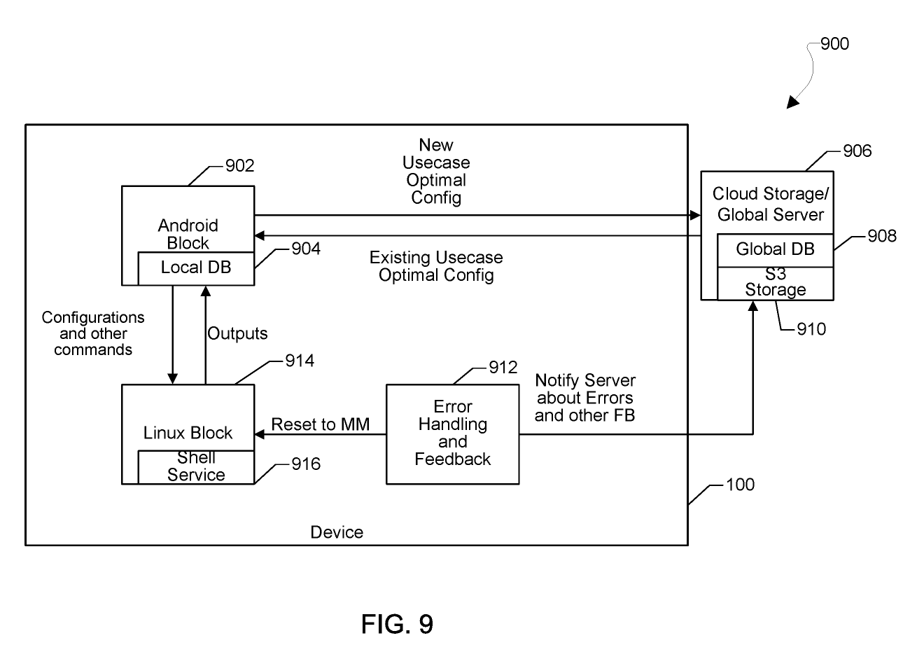

The aspect methods may be implemented in a communications device 110, having hardware components configured to perform operations of various logical blocks. An example configuration of such logical blocks within a communications device 900 implementing performance provisioning according to the various aspects is illustrated in FIG. 9.

In some aspects, the performance provisioning techniques described herein may, for example, be implemented in a computing device (e.g., communications device 100). The operations of various hardware components of the computing device (e.g., 100) and a remote server (e.g., server 600) may be organized into four operational logic blocks: an android block 902 that includes a local database 904; a Linux block 914 that includes a shell service 916; a global server block 906 that includes a global database 908 and S3 storage 910; and an error handling logical block 912.

In various aspects, the android block 902 may be responsible for a large number of functions, such as foreground activity detection, collection of feature data, maintaining a local database 904 (e.g., memory store), calculating feature data, etc.

In some aspects, the Linux block 914 may maintain the shell service 916, which enables the android block to set/reset application configurations and execute commands required for the operation of the various aspects. Via the shell service 916, the Linux block 914 may enable the android block 902 to communicate user inputs to the underlying operating system in order affect computing device configuration changes.

The global server 906 may be a cloud storage server or any other form of server that can hold and process a large amount of data as well as store (input, output) pairs for easy and quick look-up. The global server 906 may include a global database 908 such as DynamoDB, which is a fully managed NoSQL database service. The global database 908 may store the work classification model equations and best fit workload configurations. The global server 906 may also include a simple storage service (S3) to store large data files such as a collection of feature data.

The error handling and feedback block 912 may detect any anomaly in performance of the computing device (e.g., 100) after applying the performance provisioning settings. It may raise error flags and notify the global server 906 while temporarily placing the workload in an exclusion list. Work items within the exclusion list may revert their resource configuration settings back to original or settings until the issue is resolved. Once an issue is resolved by the global server 906, the work may be reclassified using the work classification model, and new performance provisioning configurations may be implemented.

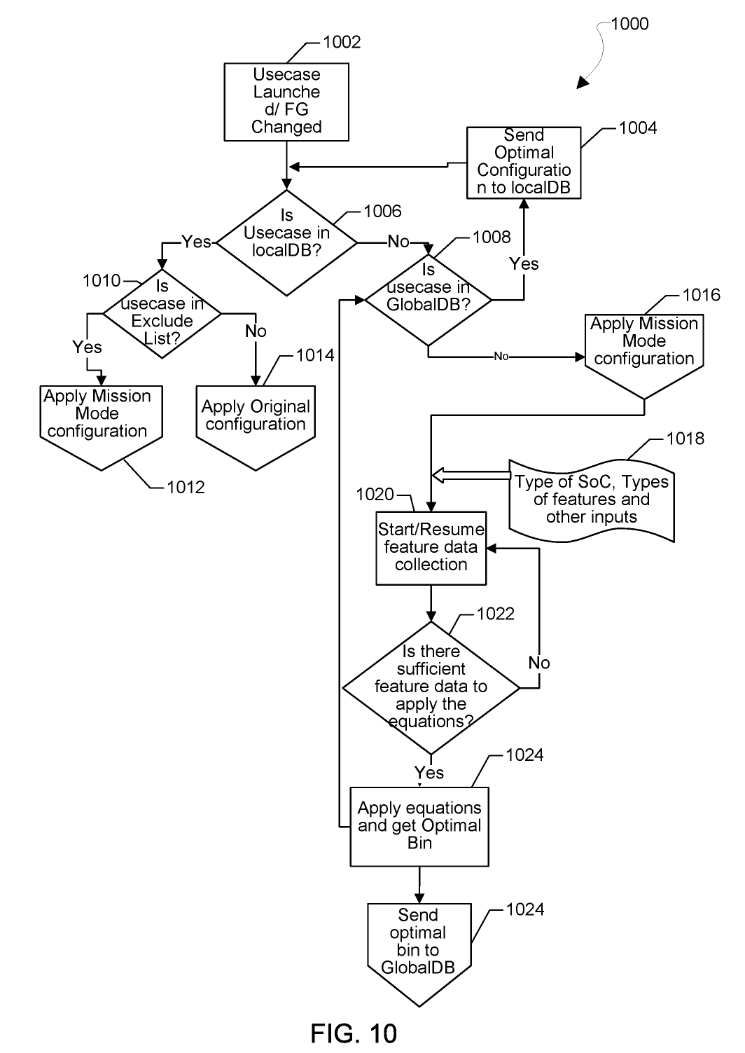

FIG. 10 illustrates a process flow diagram of a method 1000 for implementing performance provisioning of work processing in any application in accordance with various aspects. The method 1000 may be implemented on a computing device (e.g., 100) and carried out by a processor (e.g., 110) in communication with the communications subsystem (e.g., 130), and the memory (e.g., 125).

In block 1002, processor (e.g., 110) of the computing device (e.g., 100) may detect that a new use case has launched. The use case may be a work item of a software application attempting to execute on the computing device.

In determination block 1006, the processor may determine whether the launched work item has previously been stored in local memory (e.g., local database 904). The processor may access a local memory (e.g., 904) in order to compare the new work item against previously classified work items. If the work item was previously classified the processor may find a record of classification and associated best fit configuration for performance provisioning stored in local memory.

In response to determining that the launched work item is stored in local memory (i.e., determination block 1006=“Yes”), the processor may determine whether the work item is included in the exclusion list in determination block 1010. The processor may access memory (e.g., 904) and review the exclusion list to determine whether the work item should be excluded from the instant performance provisioning techniques.

In response to determining that the work item is on the exclusion list (i.e., determination block 1010=“Yes”), the processor may apply the original workload configuration to the work item in block 1012. Thus, if the work item is included in the exclusion list, the work item will not be provisioned with processing resources according to a best fit configuration associated with the work group to which it was assigned.

In response to determining that the work item is not on the exclusion rests (i.e., determination block 1010=“No”), the processor may implement the performance provisioning best fit configuration associated with the work group to which the work item was classified in block 1014. The computing device may provision the work item with processing resources according to configurations specified for the work group to which the work item was classified.

In response to determining that the launched work item is not stored in local memory, (i.e., determination block 1006=“No”), the processor may determine whether the launched work item is stored in a global database (e.g., 908) in determination block 1008. The computing device may transmit a request to the global server (e.g., 906) requesting information about the work item. The global server may access the global database in order to search for a previously stored classification of the work item.

In response to determining that the work item is stored in the global database (e.g., determination block 1008=“Yes”), the global server (e.g., 906) may transmit the classification and configuration information to the computing device in block 1004.

In response to determining that the work item is not stored in the global database (e.g., determination block 1008=“No”), the processor may apply the mission mode or standard configuration for the performance provisioning of the work item in block 1016.

In block 1020, the processor may begin or resume monitoring of the performance metrics of the work item as it executes. In block 1018, the feature data for the SoC of the computing device (e.g., 100) may be used to guide the monitoring in block 1018.

In determination block 1022, the processor may determine whether sufficient feature data for the workload item under observation has been obtained. A number of monitoring intervals or instances may be needed in order to calculate average performance ranges for each observed feature.

In response to determining that sufficient feature data has not been acquired yet (e.g., determination block 1022=“No”), the processor may continue monitoring in block 1020.

In response to determining that sufficient feature data is acquired (e.g., determination block 1022=“Yes”), the processor may apply the equations of the work classification model to the collected feature data in block 1024. By applying the work classification model to the feature data, the processor may identify a work group for the work item, and may also identify a best fit configuration for the work item type.

In block 1026, the processor may transmit the work group and best fit configuration for the work item to the global server (e.g., 906). The global server (e.g., 906) may store the received work group identification and best fit configuration data in the global database (e.g., 908).

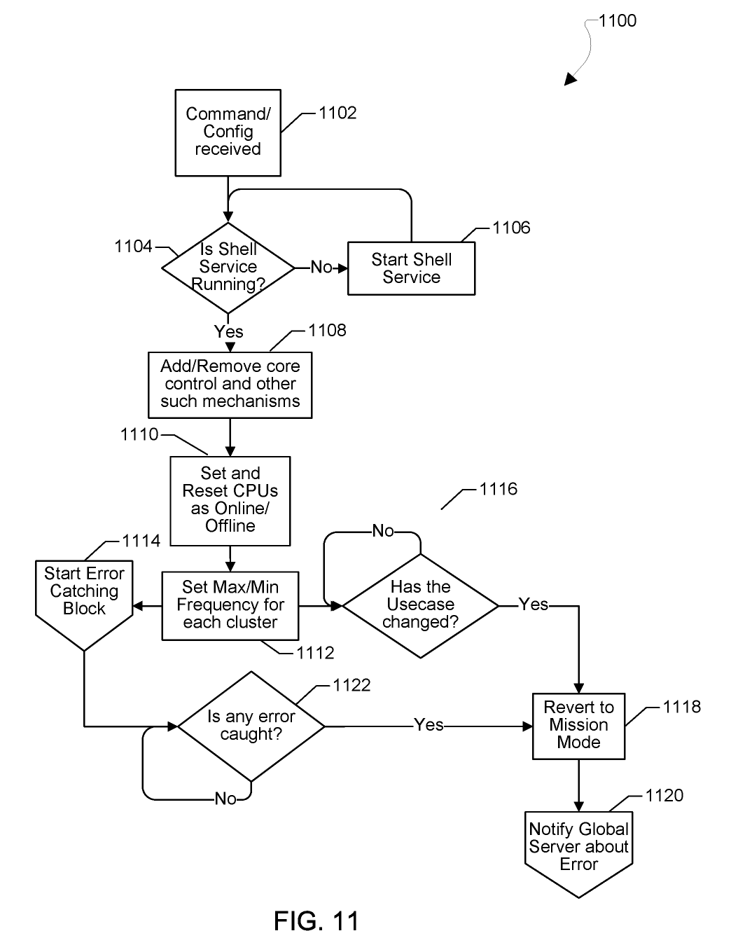

FIG. 11 illustrates a process flow diagram of a method 1100 for implementing performance provisioning of work processing in any application in accordance with various aspects. The method 1100 may be implemented on a computing device (e.g., 100) and carried out by a processor (e.g., 110) in communication with the communications subsystem (e.g., 130), and the memory (e.g., 125).

In block 1102, the processor (e.g., 110) of the computing device (e.g., 100) may receive a command or configuration request. The command/configuration request may be the performance provisioning best fit configuration for a work item according to the work group associated with the work item. Once the work item is classified into a work group and a best fit configuration associated with the work group may be identified by the android block 902, the Linux block 914 may handle provisioning of processing resources to the work item.

The Linux block 914 may control kernel interactions with the end user and the android block 902 via the shell service 916. In determination block 1104, the processor may determine whether the shell service is running.

In response to determining that the shell service is not running (i.e., determination block 1104=“No”), the processor may start the shell service in block 1106 and again determine whether the shell service is running in determination block 1104.

In response to determining that the shell service is running (i.e., determination block 1104=“Yes”), the processor may add/remove core control and other operational mechanisms in block 1108.

In block 1110, the processor may set and/or reset the CPU as being online or offline.

In block 1112, the processor may set the maximum and minimum CPU frequencies for each cluster of the SoC. The clusters may include the big and little CPU clusters.

In block 1114, the processor may begin error checking of the work item execution. Error checking may include the monitoring or observation of performance indicators (KIP) of the executing work item, as well as errors in processing of threads of the work item. The processor may instruct the error handling logic block 912 to begin monitoring for execution errors.

In determination block 1122, the processor may determine whether any errors have been detected.

In response to determining that no errors have been detected (i.e., determination block 1122=“No”), the processor may continue error checking in determination block 1122.

In response to determining that errors have been detected (i.e., determination block 1122=Yes”), the processor may revert the performance provisioning configuration to that of the mission or standard mode in block 1118.

In determination block 1116, the processor may determine whether the use case/work item has changed. In response to determining that the use case/work item has not changed (i.e., determination block 1122=“No”), the processor may continue checking for changes in use case/work item in determination block 1116.

In response to determining that the use case/work item (i.e., determination block 1116=Yes”), the processor may revert the performance provisioning configuration to that of the mission or standard mode in block 1118.

In block 1120, the processor may notify the global server (e.g., 906) that errors were detected during work item execution. The computing device may transmit a notification to the global server indicating that errors were found in the performance of the executing work item.

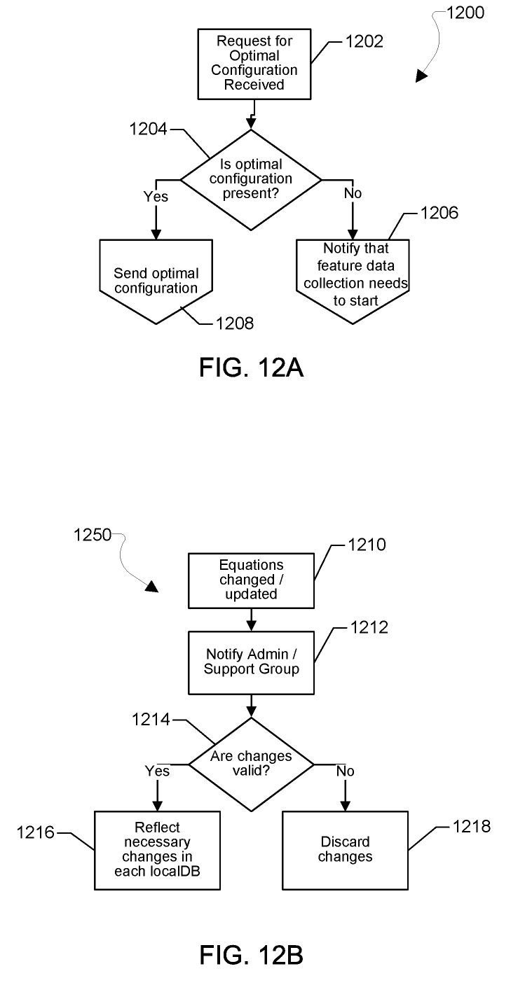

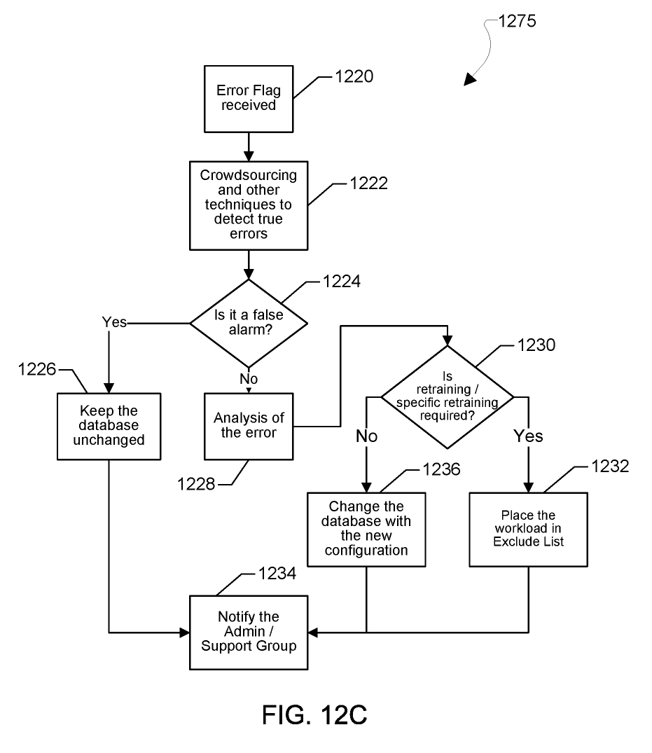

FIGS. 12A-C illustrate process flow diagrams of methods 1200, 1250, 1275 for implementing performance provisioning of work processing in any application in accordance with various aspects. The methods 1200, 1250, 1275 may be implemented on a computing device (e.g., 100) and carried out by a processor (e.g., 110) in communication with the communications subsystem (e.g., 130), and the memory (e.g., 125).

FIG. 12A illustrates a method 1200 for serving performance provisioning configuration information requests using a global server. In block 1202, the processor (e.g., 601) of the global server (e.g., 600) may receive a request for the best fit configuration information for a work item. The request may be transmitted to the global server 906 by a computing device (e.g., 100) attempting to execute the work item.

In determination block 1204, the processor (e.g., 601) of the global server (e.g., 600) may determine whether the requested configuration information is stored on the global server. As discussed with reference to block 1008 of FIG. 10, the global server 906 may review the global database 908 to determine whether the requested configuration information is stored therein. In response to determining that the requested configuration information is stored on the global server 906 (i.e., determination block 1204=“Yes”), the processor (e.g., 601) of the global server (e.g., 906) may send the requested configuration information to the requesting computing device in block 1208.

In response to determining that the requested configuration information is not stored on the global server 906 (i.e., determination block 1204=“No”), the processor (e.g., 601) of the global server (e.g., 906) may transmit a notification to feature data collection needs to start in block 1206. That is, the global server 906 may alert the requesting computing device (e.g., 100) that the computing device should begin classification of the work item and the determination of a best fit configuration for performance provisioning.

FIG. 12B illustrates a method 1200 for validating performance provisioning configuration information using a global server. In block 1210, the processor (e.g., 601) of the global server (e.g., 600) may receive changes or updates to the work classification model equations. The changes may be received from one or more computing devices (e.g., 100), such as in a crowdsourcing platform.

In block 1212, the processor (e.g., 601) of the global server (e.g., 600) may send a notification to an administrator or support personnel, notifying them of the updates.

In determination block 1214, the processor (e.g., 601) of the global server (e.g., 600) may determine whether the changes/updates are valid. The global server may perform its own error checking and or testing of the changes. The processor may check the equations for mathematical errors such as those that would result in boundary lines that tend toward infinity when mapped to the N-dimensional space.

In response to determining that the equations are valid (i.e., determination block 1214=“Yes”), the processor (e.g., 601) of the global server (e.g., 600) may in block 1216, update its local databases to reflect the change. The global server 906 may update the global database 908 and/or the S3 database 910.

In response to determining that the equations are not valid (i.e., determination block 1214=“No”), the processor (e.g., 601) of the global server (e.g., 600) may in block 1218, discard the changes.

FIG. 12C illustrates a method 1200 for error correction performance provisioning configuration information using a global server. In block 1220, the processor (e.g., 601) of the global server (e.g., 600) may receive a notification that an error has occurred. The error notification may be transmitted by a computing device (e.g., 100) attempting to execute a work item in accordance with a best fit configuration for performance provisioning. In block 1222, the processor (e.g., 601) of the global server (e.g., 600) may check stored crowd sourced error reports to determine if the current error notification is a true error. Variations in execution scenarios may occasionally result in false positives for performance errors. By reviewing pools of error reporting data, the global server 906 may be able to assess whether a reported error is a true error or merely an idiosyncrasy of a specific execution.

In determination block 1224, the processor (e.g., 601) of the global server (e.g., 600) may determine whether the error report is a false alarm. In response to determining that the error report is a false alarm, (i.e., determination block 1224=“Yes”), the processor (e.g., 601) of the global server (e.g., 600) may in block 1226, keep the databases unchanged. That is, the global server may not update the databases based on the error report. In block 1234, the processor (e.g., 601) of the global server (e.g., 600) may notify the administrator or support staff that the error report was false.

In response to determining that the error report is true, (i.e., determination block 1224=“No”), the processor (e.g., 601) of the global server (e.g., 600) may in block 1228, analyze the error report. The processor may analyze the error report to identify features that exhibited erroneous behavior during work item execution. For example, the error report may indicate that the GPU exceeded the acceptable configuration range.

In determination block 1230, the processor (e.g., 601) of the global server (e.g., 600) may determine whether retraining of the work classification model is needed. Retraining may be general, reevaluating the entire model, or may be specific to features identified in the error report. In various aspects, if the error report identifies errors across several features, then general retraining of the work classification model may be needed. Conversely, if only a single feature exhibits erroneous behavior, then limited, specific re-training may suffice.

In response to determining that retaining is not needed (i.e., determination block 1230=“No”), the processor (e.g., 601) of the global server (e.g., 600) may in block 1236, update the local databases (e.g., 908, 910) to reflect configuration changes. During determination block 1230, the processor may determine that although retraining is not needed, some tweaks to the best fit configuration associated with the erroneously executing work item (and its associated work group), may be needed. The processor may update the local databases with these changes. In block 1234, the processor (e.g., 601) of the global server (e.g., 600) may alert the administrator or support staff of the changes.

In response to determining that retaining is needed (i.e., determination block 1230=“Yes”), the processor (e.g., 601) of the global server (e.g., 600) may in block 1232, add the work item to an exclusion list. In various aspects, the exclusion list may be stored locally on the global server. Computing devices (e.g., 100) may contact the global server to check on whether work items are present on the exclusion list. In other aspects, the exclusion list may be stored individually on computing devices, and the global server may send updates to impacted devices regarding the additions/removals to the exclusion list. In block 1234, the processor (e.g., 601) of the global server (e.g., 600) may alert the administrator or support staff that retraining is needed.

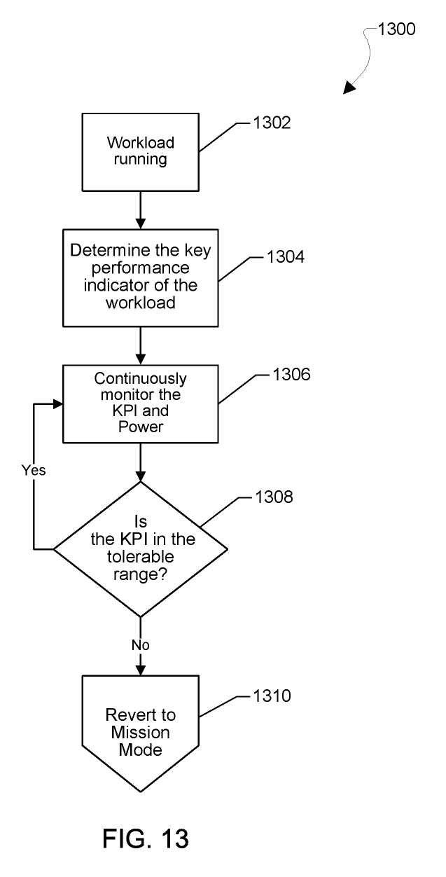

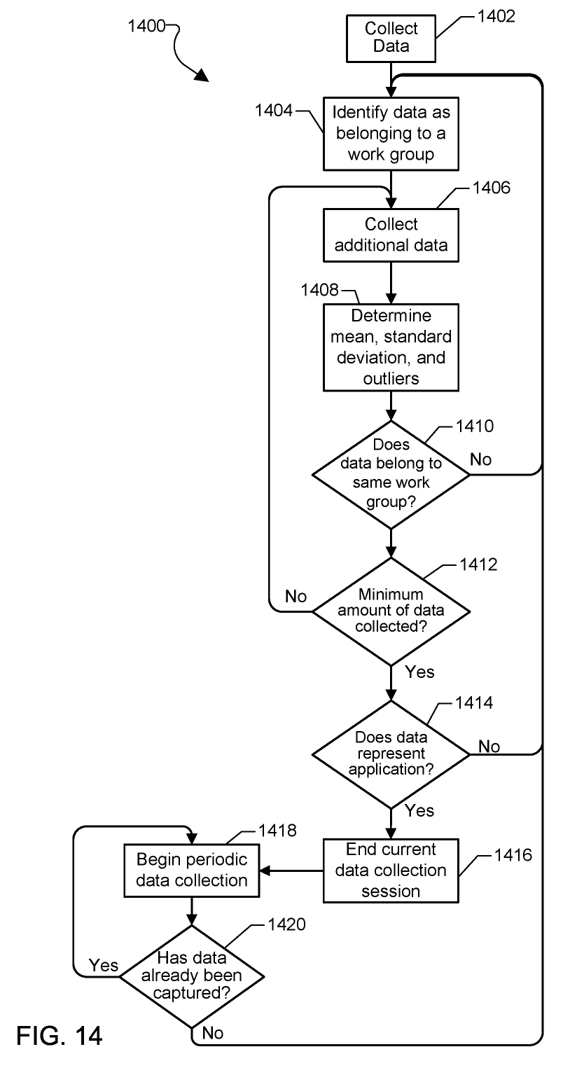

FIG. 13 illustrates a process flow diagram of a method 1300 for error correction in performance provisioning of work processing in any application in accordance with various aspects. The method 1300 may be implemented on a computing device (e.g., 100) and carried out by a processor (e.g., 110) in communication with the communications subsystem (e.g., 130), and the memory (e.g., 125).

The error handling logic block 912 may control and oversee error checking and reporting during work item execution. In block 1302, a processor (e.g., 110) of the computing device (e.g., 100) may detect that a work item (i.e., work load) is executing.

In block 1304, a processor (e.g., 110) of the computing device (e.g., 100) may identify KPI. These indicators may have been previously identified during method 700 of FIG. 7, or may be previously unknown, as in new work groups. The KPI may be behaviors that provide an indication of the quality of performance for an executing work item. Each work group may have different KPI. For example, game applications may have visual lag and input response time KPI. In block 1306, a processor (e.g., 110) of the computing device (e.g., 100) may monitor KPI of the executing work item.

In determination block 1308, the processor (e.g., 110) of the computing device (e.g., 100) may determine whether the KPI are within acceptable ranges during the work item execution. The processor may compare the performance metrics of the identified KPI to the acceptable ranges determined during method 700 of FIG. 7. In response to determining that the KPI do fall within acceptable ranges (i.e., determination block 1308=“Yes”) the processor (e.g., 110) of the computing device (e.g., 100) may continue monitoring the KPI and allow the work item to execute uninterrupted.

In response to determining that the KPI do not fall within acceptable ranges (i.e., determination block 1308=“No”), the processor (e.g., 110) of the computing device (e.g., 100) may revert the performance provisioning to mission or standard operation mode in block 1310. The work item may be added to an exclusion list while updating of the configuration information occurs.

As new software applications are installed on the computing device or current software applications are updated, new application types may be identified by the work classification model. The accuracy of work classification and the subsequent customization resource provisioning to the new software application may depend upon the computing device's ability to dynamically update the work classification model without requiring user intervention. If the work classification model is incapable of modification once deployed, then new software application types may be associated with performance provisioning rules best suited to other application types based on improper work classification. This may degrade system performance or leave the new software application unusable due lack of adequate memory or processing resources. Further, requiring the user to intervene with input regarding proper performance provisioning of each new software application installed on the computing device may impact the user experience and result in users that are less willing to install new software applications or engage in proper performance provisioning. Thus, dynamic methods for updating the work classification model to include new software application types are needed to ensure proper classification of work items and the resultant resource provisioning.

Further aspects include methods implemented on computing devices for dynamically updating a work classification model used in performance provisioning. The above described methods and computing devices may enable the generation of work groups and software application types during the generation of a work classification model. In further aspects, the computing device may generate new work groups and software application types during deployment of the work classification model. A computing device processor implementing such methods may be configured to generate a new work group by collecting computing device metric data and identify collected computing device metric data as belonging to a work group. The processor may continue to collect a second set of computing device metric data. The collected sets of data may be analyzed and a statistical analysis performed by the processor to obtain a measured quantity. This measured quantity may be used by the processor to determining whether the first set of collected computing device metric data and the second set of collected computing device metric data belong to the same work group. If the processor determines that the collected data sets belong to the same work group, the processor may determine whether it has collected a minimum amount of computing device metric data. If the processor determines that a minimum amount of computing device metric data has been collected, then the processor may determine whether the first set of collected computing device metric data and the second set of collected computing device metric data represent the software application work groups. If the processor determines that the software application is fully represented by the collected computing device metric data, then the processor may end the current data collection session and any newly identified work groups may become active.

Each software application is made up of a finite number of ‘types of work’ or work groups. For example, a gaming application may have “loading,” “selection/statistics,” and “actual game play” work groups. Each work group may exhibit patterns of system behaviors. For example, the work groups may be distinct if looked at from a combination of system parameters (i.e., computing device metrics) like CPU frequency, CPU utilization, GPU frequency, ARM instruction count, frames per second, number of touches, and gyroscope usage for example. In some aspects, the processor of the computing device may monitor these computing device metrics on a periodic basis throughout execution of a new software application and/or during regular operation of the computing device. Once the processor of the computing device has observed or collected enough computing device metric data for the software application to represent the all of the software applications various work groups, the data entirely represents the application and the processor may update the work classification model to include the new software application type.

Short periodic computing device metric monitoring intervals may enable the capture of any changes to performance provisioning needs of installed software applications. For example, a game at level 1-50 and at level 51-99 may exhibit different computing device metric behavior patterns due to an increase in game speed and/or an increase in visual elements on the screen. Some aspects include methods for updating the work classification model by the processor so that the collection of data may occur within a few minutes or levels, and may capture the change occurring at level 51 after 20 hours of game play.

Some aspects may enable the computing device processor to dynamically account for the fact that software application types exhibit computing device metric patterns that may change over time. The work classification model may be used by the processor to initially recognize data and to generate new work groups. Once work is classified into work groups, the processor may begin periodic data collection. The processor may collect data in blocks of data (e.g. five samples at a time) over a sliding window such as 10-30 seconds. The collected data may be analyzed by the processor using a standard deviation, coefficient of variation, mean, or other statistical indicator in order to determine whether the samples belong to the same work group within the software application type. If all of the collected samples belong to the same work group, then the minimum duration for data collection is met. If each work group is different, then a longer minimum duration for data collection may be needed in order to capture sufficient data. Data collection and analysis by the processor may continue at regular intervals or intervals of decreasing duration until computing device metrics for all work groups of the software application are observed by the processor. Thus, software applications with levels or work groups that are shorter in duration may be observed and analyzed by the processor in less time than those software applications with long lasting stages. Once the processor has collected enough data to classify the data into work groups, the processor may stop collecting and analyzing data for the current period. Data collection by the processor may continue periodically such as every 10 to 13 minutes.

Computing device metric data collected for a period of time and analyzed by a processor to obtain the standard deviation, coefficient of variation (for a work group), and mean is illustrated in the below data table.

| | Game X | | | | | | | | |
|---|---|---|---|---|---|---|---|---|---|
| | Average | | | Standard Deviation | | | Coefficient of Variation | | |
| | Loading | Selection | Gameplay | Loading | Selection | Gameplay | Loading | Selection | Gameplay |
| Little CPU | 992.19 | 1090.21 | 1257.96 | 284.18 | 315.36 | 152.46 | 0.29 | 0.29 | 0.12 |
| Frequency | | | | | | | | | |
| Big CPU | 1587.98 | 1254.48 | 969.74 | 333.04 | 396.30 | 256.08 | 0.21 | 0.32 | 0.26 |
| Frequency | | | | | | | | | |
| Little CPU | 30.50 | 30.66 | 41.68 | 4.73 | 6.82 | 5.84 | 0.16 | 0.22 | 0.14 |
| Utilization | | | | | | | | | |
| Big CPU | 23.11 | 17.12 | 4.16 | 9.41 | 10.86 | 9.60 | 0.41 | 0.63 | 2.31 |
| Utilization | | | | | | | | | |
| GPU Freq | 2.77E+08 | 5.01E+08 | 5.88E+08 | 5.17E+07 | 1.50E+08 | 6.66E+07 | 0.19 | 0.30 | 0.11 |
| ARM | 4.05E+08 | 7.53E+08 | 7.20E+08 | 7.52E+07 | 3.33E+07 | 3.74E+07 | 0.19 | 0.04 | 0.05 |
| Instruction | | | | | | | | | |
| Count | | | | | | | | | |
| FPS | 27.38 | 57.78 | 58.91 | — | — | — | — | — | — |
| Touches per | <10 | 10-30 | >30 | — | — | — | — | — | — |
| min/Gyro | | | | | | | | | |

In some aspects, the processor may perform methods implementing the statistical analyses described herein and illustrated in the foregoing data table. In some aspects, the processor may perform methods based, at least in part, on the occurrence and number of outliers. In some aspects, the processor may perform methods based, at least in part, on differential moving averages. In some aspects, the processor may utilize unsupervised machine learning to recognize patterns in computing device metrics.

The various aspects may enable the computing device to automatically determine when to stop collecting data, thereby avoiding unnecessary collection that could over burden system resources, needlessly slow overall processing, or unnecessary drain power from a battery of the computing device. For example, some games may not vary greatly even if played for lengthy durations of time. Computing device metrics observed over a couple of minutes would be similar to that collected over hours. However, some games may have various missions/levels that require substantially varying degrees of system resource utilization. Computing device metric data collected at the beginning of game play may not be similar to data collected at a later point in the game. Hence, setting a predefined duration of data collection may collect excess data or insufficient data, thereby leading to properly tailored performance provisioning. Various aspects may enable the computing device processor to appropriately provision resources instead of over-provisioning for performance or under-provisioning for power.

FIG. 14 illustrates a process flow diagram of a method 1400 for updating a work classification model to accommodate new or updated software application types in accordance with various aspects. The method 1400 may be implemented on a computing device (e.g., 100) and carried out by a processor (e.g., 110) coupled to memory (e.g., 125). The computing device may include a communications subsystem (e.g., 130).

In block 1402, the computing device processor may collect data (e.g., computing device metrics). Computing device metric data may be collected by the processor over a sliding window of time. For example, the processor may first analyze the first “1 to N” data points, then analyze data points “2 to N+1”, “3 to N+2”, and so on. The use of sliding time windows may reduce the impact of outliers on descriptive statistics.

In block 1404, the processor may identify the collected computing device metric data as belonging to a work group. Each work group may be different when looked at from a combination of computing device metrics, and each work group may exhibit different patterns. For example, loading stage work groups may have high Big CPU frequency and utilization with low GPU frequency, while gameplay work groups may exhibit the opposite computing device metric pattern. The presence of a work group may be identified by the processor based on a demonstrated pattern in observed computing device metrics. The pattern may be one that is already associated with a preexisting work group of the work classifier model, or may be a new or update work group exhibiting new computing device metric patterns.

In block 1406, the processor may continue collecting computing device metric data in preparation for statistical data analysis. In block 1408 the processor of the computing device may perform a statistical data analysis on the collected data. For example, the processor may calculate the standard deviation and mean of the collected computing device metric data, and may further calculate the coefficient of variation for the identified group.

In determination block 1410, the processor may determine whether all the collected data belongs to the identified work group. The processor may compare the collected data to one or more thresholds associated with acceptable variations in the mean, standard deviation, median, number (or percentage) of outliers of the collected computing device metric data, etc. When the work group associated with the second set of collected computing device metric data differs from the identified work group of the first set of collected computing device metric data, the processor may detect sudden upticks/downticks in the measured quantity, and this change, if continued, may be sufficient to push the measured quantity out of the accepted variation threshold. To avoid burst changes in computing device metrics, several seconds of collected data may be observed and analyzed to detect changes in the measured quantity.

In response to determining that all the collected data does not belong to the identified work group (i.e., determination block 1410=“No”), the processor may again identify a work group to which the second set of collected data belongs in block 1404.

In response to determining that all the collected data does belong to the identified work group (i.e., determination block 1410=“Yes”), the processor may determine whether a minimum amount of data has been collected in determination block 1412. The processor may set and store in memory a minimum acceptable amount of computing device metric data for collection. Setting a minimum acceptable amount of collected data may reduce the likelihood that the various methods will end before all work groups of a software application have been observed and analyzed. For example, without a minimum duration, the processor may terminate data collection and miss subsequent sustained variation in the measured statistical quantity if the processor detects no variation within the first couple of data points.

In response to determining that a minimum amount of data has not been collected (i.e., determination block 1412=“No”), the processor may continue collecting computing device metric data in block 1406.

In response to determining that a minimum amount of data has been collected (i.e., determination block 1412=“Yes”), the processor may determine whether the collected data represents the software application in determination block 1414. Specifically, the processor may determine whether the collected computing device metric data represents the entirety of the software application's various work groups. The processor may make this determine based, at least in part, on the number of work groups already identified, the amount of data already collected, and the amount of variation. The processor may determine that all work groups of the software application have been identified and that the collected data represents the software application in its entirety once work groups are stable and or repeating.

In response to determining that the collected data does not represent the software application (i.e., determination block 1414=“No”), the processor may again identify a work group to which the collected data belongs in block 1404.

In response to determining that the collected data represents the software application (i.e., determination block 1414=“Yes”), the processor may end the current data collection session in block 1416.

In block 1416, the processor may begin periodic data checks. The processor may perform such periodic checks to determine whether variations in data at later stages of the software application execution have been previously captured. Thus, the periodic checks may enable the identification of new work groups within an existing software application (e.g., as players reach new game levels or new application features are added).

In response to determining that the data collected during a periodic check has already been captured (i.e., determination block 1420=“Yes”), the processor may continue performing periodic checks in block 1418. In various aspects, the duration of time in between periodic checks may increase as the number of “yes” response to determination block 1420 increases and may reset to a minimum interim duration when a “no” response is returned.

In determination block 1420, the processor may determine whether the data collected during a periodic check has already been captured. Data may have been previously captured during a prior periodic check or during the first observation of a new work group or software application type. In response to determining that the data collected during a periodic check has not already been captured (i.e., determination block 1420=“No”), the processor may again identify a work group to which the collected computing device metric data belongs in block 1404.

In this manner, the various aspects may enable the identification of new software applications and work groups, as well as the updating of the work classification model to include new work groups of existing software applications. Once a work item is classified into a work group, performance provisioning rules may be selected and the application executed with improved resource provisioning.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a subscription and data receiving associated with a different subscription, such identifiers are merely for convenience and are not meant to limit various aspects to a particular order, sequence, type of network or carrier.

Various illustrative logical blocks, modules, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more example aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method for resource provisioning using work classification, comprising:
generating, by a processor of a computing device, a work group;
classifying, by the processor, a new work item for a software application into the generated work group using a work classification model;
selecting, by the processor, a set of provisioning rules for the work item based, at least in part, on the work group to which the work item was classified; and
executing, by the processor, the work item according to the selected set of provisioning rules.

2. The method of claim 1 wherein generating the work group comprises:
identifying, by the processor, that a first set of collected computing device metric data belongs to a work group;
collecting a second set of computing device metric data;
analyzing the first set of collected computing device metric data and the second set of collected computing device metric data to obtain a measured quantity;
determining whether the first set of collected computing device metric data and the second set of collected computing device metric data belong to the same work group based on the measured quantity;
determining whether the first set of collected computing device metric data and the second set of collected computing device metric data represent software application work groups in response to determining that the first set of collected computing device metric data and the second set of collected computing device metric data belong to the same work group; and
ending a current data collection session in response to determining that the first set of collected computing device metric data and the second set of collected computing device metric data represent the software application work groups.

3. The method of claim 2, wherein computing device metrics comprise at least one of graphical processing unit (GPU) frequency range, central processing unit (CPU) frequency for a cluster of little CPUs, CPU frequency for a cluster of big CPUs, CPU utilization of the cluster of little CPUs, CPU utilization of the cluster of big CPUs, or advanced RISC machine (ARM) instructions.

4. The method of claim 2, further comprising:
determining whether a minimum amount of computing device metric data has been collected in response to determining that the first set of collected computing device metric data and the second set of collected computing device metric data belong to the same work group,
wherein determining whether the first set of collected computing device metric data and the second set of collected computing device metric data represent the software application work groups is performed further in response to determining that a minimum amount of computing device metric data has been collected.

5. The method of claim 2, wherein the measured quantity is one or more of a mean, standard deviation, median, number of outliers, percentage of outliers, or a coefficient of variation.

6. The method of claim 1, further comprising:
storing, by the processor, performance metrics of classified work items;
determining, by the processor, whether the stored performance metrics meet a performance quality threshold; and
training the work classification model, by the processor, in response to determining that the stored performance metrics do not meet the performance quality threshold.

7. The method of claim 1, further comprising:
storing performance metrics of classified work items;
transmitting, by the processor via a transceiver of the computing device, the stored performance metrics to a remote server; and
receiving, by the processor via the transceiver, an updated work classification model from the remote server.

8. The method of claim 7, further comprising:
determining, by the processor, whether the stored performance metrics meet a performance quality threshold; and
transmitting, by the processor via the transceiver, a request for an updated classification model in response to determining that the stored performance metrics do not meet a performance quality threshold.

9. The method of claim 1, wherein classifying a new work item for a software application into a work group using the work classification model comprises matching, by the processor, a software application type of the software application to which the work item belongs to a software application type associated with one or more work groups.

10. A computing device, comprising:
a processor configured with processor-executable instructions to perform operations comprising:
generating a work group;
classifying a new work item for a software application into the generated work group using a work classification model;
selecting a set of provisioning rules for the work item based, at least in part, on the work group to which the work item was classified; and
executing the work item according to the selected set of provisioning rules.

11. The computing device of claim 10, wherein the processor is further configured with processor-executable instructions to perform operations such that generating the work group comprises:
identifying that a first set of collected computing device metric data belongs to a work group;
collecting a second set of computing device metric data;
analyzing the first set of collected computing device metric data and the second set of collected computing device metric data to obtain a measured quantity;
determining whether the first set of collected computing device metric data and the second set of collected computing device metric data belong to the same work group based on the measured quantity;
determining whether the first set of collected computing device metric data and the second set of collected computing device metric data represent software application work groups in response to determining that the first set of collected computing device metric data and the second set of collected computing device metric data belong to the same work group; and
ending a current data collection session in response to determining that the first set of collected computing device metric data and the second set of collected computing device metric data represent the software application work groups.

12. The computing device of claim 11, wherein the processor is further configured with processor-executable instructions to perform operations such that computing device metrics comprise at least one of graphical processing unit (GPU) frequency range, central processing unit (CPU) frequency for a cluster of little CPUs, CPU frequency for a cluster of big CPUs, CPU utilization of the cluster of little CPUs, CPU utilization of the cluster of big CPUs, or advanced RISC machine (ARM) instructions.

13. The computing device of claim 11, wherein the processor is further configured with processor-executable instructions to perform operations comprising:
determining whether a minimum amount of computing device metric data has been collected in response to determining that the first set of collected computing device metric data and the second set of collected computing device metric data belong to the same work group,
wherein the processor is further configured to perform operations such that determining whether the first set of collected computing device metric data and the second set of collected computing device metric data represent the software application work groups is performed further in response to determining that a minimum amount of computing device metric data has been collected.

14. The computing device of claim 11, wherein the processor is further configured with processor-executable instructions to perform operations such that the measured quantity is one or more of a mean, standard deviation, median, number of outliers, percentage of outliers, or a coefficient of variation.

15. The computing device of claim 10, wherein the processor is further configured with processor-executable instructions to perform operations comprising:
storing performance metrics of classified work items;
determining whether the stored performance metrics meet a performance quality threshold; and
training the work classification model, by the processor, in response to determining that the stored performance metrics do not meet the performance quality threshold.

16. The computing device of claim 10, further comprising a transceiver, wherein the processor is coupled to the transceiver and further configured with processor-executable instructions to perform operations comprising:
storing performance metrics of classified work items;
transmitting the stored performance metrics to a remote server; and
receiving an updated work classification model from the remote server.

17. The computing device of claim 16, wherein the processor is further configured with processor-executable instructions to perform operations comprising:
determining whether the stored performance metrics meet a performance quality threshold; and
transmitting a request for an updated classification model in response to determining that the stored performance metrics do not meet a performance quality threshold.

18. The computing device of claim 10, wherein the processor is further configured with processor-executable instructions to perform operations such that classifying a new work item for a software application into a work group using the work classification model comprises matching, by the processor, a software application type of the software application to which the work item belongs to a software application type associated with one or more work groups.

19. A computing device, comprising:
means for generating a work group;
means for classifying a new work item for a software application into the generated work group using a work classification model;
means for selecting a set of provisioning rules for the work item based, at least in part, on the work group to which the work item was classified; and
means for executing the work item according to the selected set of provisioning rules.

20. The computing device of claim 19, wherein the means for generating the work group comprises:
means for identifying that a first set of collected computing device metric data belongs to a work group;
means for collecting a second set of computing device metric data;
means for analyzing the first set of collected computing device metric data and the second set of collected computing device metric data to obtain a measured quantity;
means for determining whether the first set of collected computing device metric data and the second set of collected computing device metric data belong to the same work group based on the measured quantity;
means for determining whether the first set of collected computing device metric data and the second set of collected computing device metric data represent software application work groups in response to determining that the first set of collected computing device metric data and the second set of collected computing device metric data belong to the same work group; and
means for ending a current data collection session in response to determining that the first set of collected computing device metric data and the second set of collected computing device metric data represent the software application work groups.

21. The computing device of claim 20, further comprising:
means for determining whether a minimum amount of computing device metric data has been collected in response to determining that the first set of collected computing device metric data and the second set of collected computing device metric data belong to the same work group,
wherein means for determining whether the first set of collected computing device metric data and the second set of collected computing device metric data represent the software application work groups comprises means for determining whether the first set of collected computing device metric data and the second set of collected computing device metric data represent the software application work groups further in response to determining that a minimum amount of computing device metric data has been collected.

22. The computing device of claim 19, further comprising:
means for storing performance metrics of classified work items;
means for determining whether the stored performance metrics meet a performance quality threshold; and
means for training the work classification model in response to determining that the stored performance metrics do not meet the performance quality threshold.

23. The computing device of claim 19, further comprising:
means for storing performance metrics of classified work items;
means for transmitting the stored performance metrics to a remote server; and
means for receiving an updated work classification model from the remote server.

24. The computing device of claim 23, further comprising:
means for determining whether the stored performance metrics meet a performance quality threshold; and
means for transmitting a request for an updated classification model in response to determining that the stored performance metrics do not meet a performance quality threshold.

25. A non-transitory processor-readable medium having stored thereon processor-executable instructions configured to cause a processor of a computing device to perform operations comprising:
generating a work group;
classifying a new work item for a software application into the generated work group using a work classification model;
selecting a set of provisioning rules for the work item based, at least in part, on the work group to which the work item was classified; and
executing the work item according to the selected set of provisioning rules.

26. The non-transitory processor-readable medium of claim 25, wherein the stored processor-executable instructions are further configured to cause the processor of the computing device to perform operations such that generating the work group comprises:
identifying that a first set of collected computing device metric data belongs to a work group;
collecting a second set of computing device metric data;
analyzing the first set of collected computing device metric data and the second set of collected computing device metric data to obtain a measured quantity;
determining whether the first set of collected computing device metric data and the second set of collected computing device metric data belong to the same work group based on the measured quantity;
determining whether the first set of collected computing device metric data and the second set of collected computing device metric data represent software application work groups in response to determining that the first set of collected computing device metric data and the second set of collected computing device metric data belong to the same work group; and
ending a current data collection session in response to determining that the first set of collected computing device metric data and the second set of collected computing device metric data represent the software application work groups.

27. The non-transitory processor-readable medium of claim 26, wherein the stored processor-executable instructions are further configured to cause the processor of the computing device to perform operations comprising:
determining whether a minimum amount of computing device metric data has been collected in response to determining that the first set of collected computing device metric data and the second set of collected computing device metric data belong to the same work group,
wherein the stored thereon processor-executable instructions are further configured to cause the processor of the computing device such that determining whether the first set of collected computing device metric data and the second set of collected computing device metric data represent the software application work groups is performed further in response to determining that a minimum amount of computing device metric data has been collected.

28. The non-transitory processor-readable medium of claim 25, wherein the stored processor-executable instructions are further configured to cause the processor of the computing device to perform operations comprising:
storing performance metrics of classified work items;
determining whether the stored performance metrics meet a performance quality threshold; and
training the work classification model, by the processor, in response to determining that the stored performance metrics do not meet the performance quality threshold.

29. The non-transitory processor-readable medium of claim 25, wherein the stored processor-executable instructions are further configured to cause the processor of the computing device to perform operations comprising:
storing performance metrics of classified work items;
transmitting the stored performance metrics to a remote server; and
receiving an updated work classification model from the remote server.

30. The non-transitory processor-readable medium of claim 29, wherein the stored processor-executable instructions are further configured to cause the processor of the computing device to perform operations comprising:
determining whether the stored performance metrics meet a performance quality threshold; and
transmitting a request for an updated classification model in response to determining that the stored performance metrics do not meet a performance quality threshold.
